(19) United States
(12) Patent Application Publication
(10) Pub. No.: US 2008/0071564 A1
(43) Pub. Date: Mar. 20, 2008

(54) System And Method For Processing Real Estate Opportunities

(76) Inventor: Rodney H. Thomas, Earth City, MO (US)

Correspondence Address: LATHROP & GAGE LC, 4845 PEARL EAST CIRCLE, SUITE 300, BOULDER, CO, 80301, US

(21) Appl. No.: 11/842,625

(22) Filed: Aug. 21, 2007

Related U.S. Application Data
(60) Provisional application No. 60/839,020, filed on Aug. 21, 2006.

(51) Int. Cl. G06Q 30/00

(52) U.S. Cl. 705/1

(57) ABSTRACT

A software product having instructions, stored on computer-readable media, wherein the instructions, when executed by a computer, perform steps for operating a web site to encourage a broker to process real estate opportunities includes instructions for identifying the broker interacting with the web site, instructions for receiving a proposal from the broker, the proposal including at least one of the real estate opportunities, instructions for presenting compensation options to the broker, instruction for accepting selection of one of the compensation options by the broker, and instructions for facilitating compensation of the broker upon closure of the real estate opportunity based upon broker's selection of compensation options.

### RELATED APPLICATIONS

This application claims priority to U.S. provisional patent application No. 60/839,020 titled “System and Method for Processing Real Estate Opportunities” filed on 21 Aug. 2006, incorporated herein by reference.

### COPYRIGHTS

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BACKGROUND

Companies engaged in the business of acquiring and/or developing real estate for investment and/or sale are constantly seeking suitable purchase opportunities. Real estate opportunities often arise on a local basis and are frequently discovered by local real estate brokers.

A broker may submit a proposal for the development or sale of real estate to an organization in a position to facilitate the proposal. In return for the submission, the broker typically earns a fixed percentage of the transaction price or a fixed amount (a commission) based on the size or dollar value of the proposal when the proposal ‘closes’ (i.e., the real estate is purchased). This compensation is paid to the broker at or around the time of the closing as outlined in the proposal.

### SUMMARY OF THE INVENTION

Although the broker has an incentive to bring the proposal to closure (to receive the associated commission), the fixed basis of compensation, paid at or around closure of the proposal, fails to provide the broker with any interest in the short-term and long-term success of the subject matter of the proposal Accordingly, the broker has no interest in the real estate transaction beyond the closing of the proposal and therefore lacks incentive to present real estate opportunities to development companies. Systems and methods disclosed hereinbelow may, for example, change the dynamics between the broker and development companies.

Briefly, there are two broad categories of value-creation in real estate acquisition and development: 1) purchasing property below market value, and 2) purchasing property and then adding value by improving it. Adding value can include situations as diverse as: entitling vacant land; retrofitting an old industrial building; filling up a partially empty office building; and greenfield development. Of course, any combination of 1 and 2 may be practiced.

Identifying good real estate opportunities involves: finding or being exposed to properties that are available for purchase; and evaluating properties that are found to eliminate those with problems or low potential. In the bricks and mortar world, real estate purchasers often have a reputation about what types of deals they like and those are often the kinds of deals presented to them. Evaluations then proceed with purchasers gathering information about the properties which is analyzed using a combination of logical analysis based on property and market conditions along with intuition based on past experience.

The process often works not by identifying good deals but by ruling out bad deals. For example, properties may be ruled out because the price is not attractive or there are problems with legal or market situations. As long as properties generally seem like worthwhile acquisition candidates they will proceed along toward acceptance unless a problem crops up. Each stage of the approval process is really a ‘tightening’ of the evaluation of the proposed property. If a property finally makes it all the way through these tighter and tighter stages of evaluation, it will eventually emerge from the last phase of due diligence as a property that should be closed.

Some of the factors that go into property evaluation are, for example: how does the purchase price compare to local market comparables; what is the best future use for the property (if not the current use); what are the local market and demographic conditions that will affect the absorption of the property; are there any potential political or zoning issues that will make the intended use of the property a problem; are there any legal or title issues restricting the use of the property; are there any physical limitations on the use of the property such as lack of utilities, topography etc.; and are there any environmental issues.

Accordingly, certain of the foregoing processes are automated by systems and methods disclosed hereinbelow to process real estate opportunities. For example, the system may offer a broker submitting a real estate proposal a choice in compensation. In this example, the Broker is given the choice of a cash commission from the buyer and/or a participatory interest in the real estate being proposed. A formula may be used to determine an appropriate compensation level for the Broker based upon the type and size of the proposed real estate deal. The system may instead offer the broker the choice of a participatory interest in the real estate while also receiving a seller's compensation.

In one embodiment, therefore, a software product has instructions, stored on computer-readable media, wherein the instructions, when executed by a computer, perform steps for operating a web site to encourage a broker to process real estate opportunities, including: instructions for identifying the broker interacting with the web site; instructions for receiving a proposal from the broker, the proposal including at least one of the real estate opportunities; instructions for presenting compensation options to the broker; instruction for accepting selection of one of the compensation options by the broker; and instructions for facilitating compensation of the broker upon closure of the real estate opportunity based upon broker's selection of compensation options.

In another embodiment, a system processes a real estate opportunity, and includes: a database for storing experience data, research data, proposal data and evaluation rules; a web site host for operating a web site in the interet, the web site host receiving a proposal including the real estate opportunity from a broker interacting with the web site, the web site presenting the broker with a choice of compensation options and receiving a compensation option selection from the broker; and an evaluation module for utilizing the database to determine if the real estate opportunity is acceptable to a buyer, the evaluation module generating a contract between a seller of the real estate of the real estate opportunity and the buyer if the real estate opportunity is acceptable, such that the broker receives the selected compensation upon closure of the contract.

In another embodiment, a software product has instructions, stored on computer-readable media, wherein the instructions, when executed by a computer, perform steps for operating a web site to encourage a broker to present a real estate opportunity and automatically determining if the real estate opportunity is suitable for a buyer, including: instructions for identifying the broker interacting with the web site; instructions for receiving a proposal from the broker, the proposal including the real estate opportunity; instructions for presenting a choice of compensation options to the broker; instructions for accepting a compensation selection from the broker; instructions for generating documentation between the buyer and the broker; instructions for receiving the broker's electronic signature indicating the broker's agreement with the documentation; instructions for receiving detailed information of the proposal; instructions for determining if the real estate opportunity has been previously submitted by another broker; instructions for verifying the accuracy of the proposal; instructions for registering the broker and the proposal; instructions for evaluating the proposal to determine if the proposal is suitable for presenting to the buyer; instructions for preparing a contract for a seller of the real estate in the proposal; instructions for performing due diligence on the real estate of the proposal to determine if the opportunity should be taken; instructions for facilitating closure of the contract between the seller and the buyer; and instructions for compensating the broker based upon the broker's compensation selection.

### BRIEF DESCRIPTION OF THE FIGURES

FIG. 1 shows one exemplary system embodiment for processing real estate opportunities.

FIG. 2 shows an exemplary evaluation module of the system of FIG. 1.

FIGS. 3A-3D shows a flowchart illustrating one exemplary method for processing real estate opportunities.

FIGS. 4-29D show exemplary web pages for processing real estate opportunities.

### DETAILED DESCRIPTION OF THE FIGURES

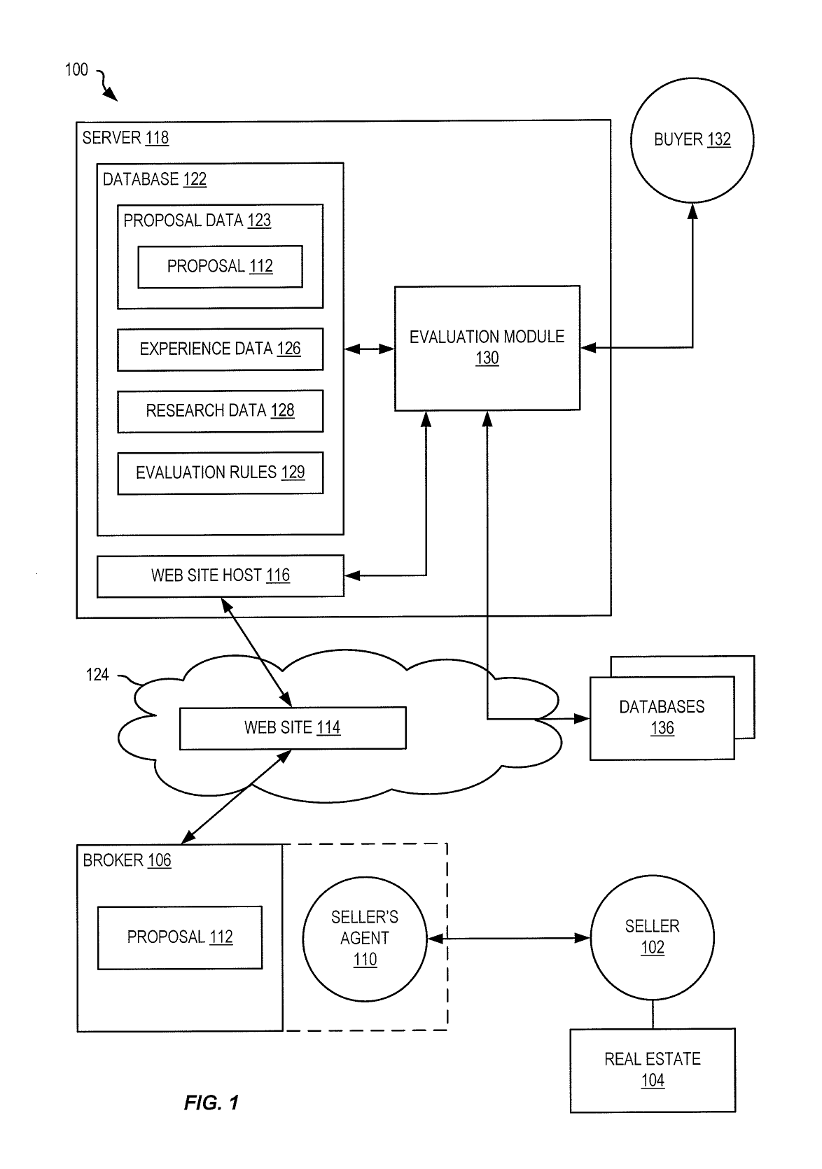

FIG. 1 shows one exemplary system 100 for processing real estate opportunities. A buyer 132 operates system 100 to encourage brokers to present real estate opportunities to buyer 132. System 100 is, for example, implemented by a server 118. Server 118 represents a computer system that may include one or more processors, random access memory, non-volatile memory, non-volatile data storage (e.g., a magnetic disk drive) and various interfaces that allow communication with server 118. Server 118 is shown with a database 122, a web site host 116 and evaluation module 130. Web site host 116 hosts web site 114 on Internet 124. Alternatively, web site host 116 may be located on another computer (not shown) that communicates with server 118. Web site host 116 generates web pages, for display on web site 114, to interact with broker 106, for example.

In operation, a seller 102 has real estate 104 to sell. Broker 106 identifies real estate 104 as an item of possible interest to buyer 132. Seller 102 may utilize a seller's agent 110 to represent seller 102 during sale of real estate 104. Broker 106 may operate as seller's agent 110 (as indicated by dashed lines in FIG. 1) to represent seller 102. Broker 106 may prepare a proposal 112 detailing real estate 104. Broker 106, after negotiation with seller 102 and/or seller's agent 110, interacts with web site 114 and enters basic details (e.g., location, size, existing structures, price, etc.) of proposal 112. Broker 106 may enter other relevant information into proposal 112, such as a desired closing date, lease rates, etc., required by seller 102. Web site host 116 thus interacts with broker 106 and facilitates transfer of information between broker 106 and server 118.

Web site 114 may require that broker 106 supply a user name and password before being allowed to submit information to server 118. In this event, upon a first use of web site 114, broker 106 may be asked to enter identifying information (e.g., information relating to one or more of name, address, real estate license information, telephone number, email address, etc.) and to select a unique user name and password; the username and password may then be used for future access to web site 114. This identifying information is hereinafter referred to as broker information and may be stored within database 122 of server 118.

Upon submission of proposal 112 to web site 114, broker 106, using options presented on web site 114, selects a desired method of compensation. In one embodiment, selection of the desired level of compensation also defines a desired level of broker participation for proposal 112. In another embodiment, broker 106 selects his participatory level by further interaction with web site 114. For example, broker 106 may select compensation based upon a participatory interest in real estate 104, thereby agreeing to act as an associate broker, representing buyer 132 and sharing in profits resulting from on-going operation and/or sale of real estate 104. In another example, broker 106 may elect a non-participatory compensation based upon an agreed seller commission from seller 102, thereby agreeing to act as a commissioned buyer's agent representing buyer 132. In another example, broker 106 may elect to act as both a commissioned broker and an associate broker (a “dual agent”), thereby receiving both seller commission from seller 102 and a participatory interest in real estate 104.

The amount of participatory interest may for example be X% (e.g., ten percent) of the closure value of real estate 104. In this case, broker 106 is, in effect, a partial owner of real estate 104 and receives compensation immediately upon sale of the real estate. The participatory interest may be, in addition or alternatively, Y% (e.g., ten percent) of future profits relating to operation and/or sale of real estate 104. In this case, broker 106 is invested in operation of real estate 104 and/or invested in increasing retail value of real estate 104. System 100 may further permit broker 106 to make additional investments (by investing additional money in lieu of or in excess to an immediate compensation) in proposal 112, thereby increasing potential returns from closure of the proposal. By making additional investments, broker 106 may also incur liability for debts incurred by the property. System 100 may facilitate negotiations directly between buyer 132 and broker 106.

Web site 114 may thus encourage broker 106 to locate suitable property for purchase and/or development by buyer 132 by providing opportunity for additional participation by broker 106 in real estate 104. Further, web site 114 is open to submission by new brokers. Thus, incentives to brokers and availability of web site 114 may encourage submission of real estate opportunities to buyer 132.

Once broker 106 has submitted proposal 112 and selected a desired method of compensation, an evaluation module 130 first determines if proposal 112 is complete and whether real estate 104 has been included within a proposal by another broker. In one example, evaluation module 130 searches proposal data 123 of database 122 to determine if real estate 104 has already been registered. Evaluation module 130 may, for example, compare addresses of real estate stored within proposal data 123 against an address of real estate 104. If real estate 104 has already been registered submitted by a broker and accepted by evaluation module 130, evaluation module 130 rejects proposal 112, notifying broker 106 of the rejection and removing proposal 112 from database 122.

A registered proposal may be maintained within database 122 for a certain period (e.g., one year) even if the proposal does not result in closure, thereby protecting the rights of the broker that introduced the real estate. After one year, if closure does not result, the proposal is removed from database 122, allowing other proposals for the same real estate to be submitted by any broker. The first broker to submit, and have accepted, a proposal for a piece of real estate becomes the buyer's agent for that real estate for a minimum period (e.g., one year).

If real estate 104 is not currently registered within proposal data 123, evaluation module 130 adds proposal 112 to proposal data 123, thereby registering proposal 112 as submitted by broker 106 and assigning broker 106 as buyer 132's agent for real estate 104. Evaluation module 130 then performs an initial evaluation of proposal 112 to determine if proposal 112 is of interest to buyer 132. In one embodiment, evaluation module 130 utilizes evaluation rules 129 of database 122 to retrieve data relevant to proposal 112 (e.g., based upon recent property transactions local to real estate 104) to determine if proposal 112 is suitable for consideration by buyer 132. Evaluation module 130 may utilize one or both of experience data 126 and research data 128 within database 122 during evaluation of proposal 112. Evaluation module 130 may also utilize other databases 136, via Internet 124, to determine information pertinent to real estate 104. Databases 136 may, for example, represent publicly available databases and/or private databases accessible through a subscription service.

As appreciated, the ultimate decision to proceed with the purchase of real estate 104 is made by buyer 132, however, evaluation module 130 removes the burden of viewing inappropriate proposals from buyer 132 by automatically rejecting incomplete and/or unsuitable proposals. In one embodiment, buyer 132 configures evaluation module 130 by defining rules for acceptable proposals within evaluation rules 129. For example, buyer 132 may specify an evaluation rule (for rules 129) to reject proposals with a transaction value less than $3M. In another example, buyer 132 may specify an evaluation rule to reject proposals within a certain area. In another example, buyer 132 may specify an evaluation rule that determines an estimated value of real estate 104 by searching for similar recent real estate transactions within a certain radius of real estate 104 and then applying a formula to adjust the estimated value based upon differences between the identified recent real estate transactions and real estate 104. In another example, buyer 132 specifies an evaluation rule 129 that retrieves the property value of real estate 104 recently used for tax purposes.

If evaluation module 130 determines that proposal 112 is worth consideration by buyer 132, evaluation module 130 notifies buyer 132 of proposal 112 (e.g., automatically by email). If buyer 132 decides to pursue the real estate opportunity of proposal 112, buyer 132 instructs evaluation module 130 to proceed towards closure of proposal 112. Evaluation module 130 may, for example, notify broker 106 to also proceed towards closure of proposal 112. Buyer 132, broker 106 and seller's agent 110 (if not broker 106) then work together to bring proposal 112 to closure. If broker 106 selected compensation by participatory interest in real estate 104, evaluation module 130 generates a contract between buyer 132 and broker 106 covering such agreements; broker 106 then has participatory interest in real estate 104 upon closure.

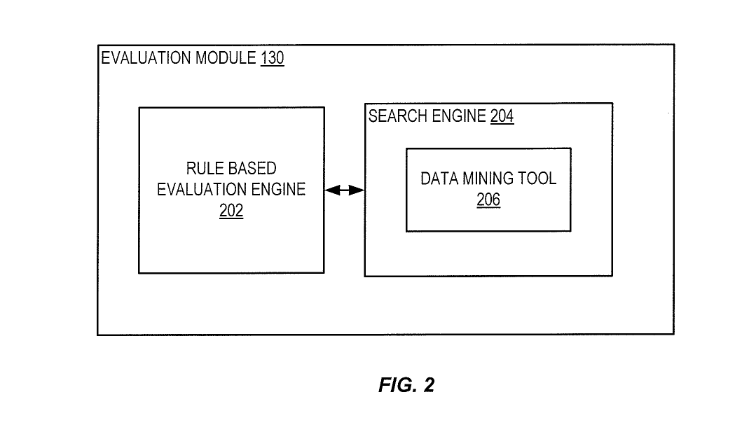

FIG. 2 shows evaluation module 130 of FIG. 1 with a rule based evaluation engine 202 and a search engine 204. Search engine 204 facilitates retrieval of data pertinent to proposal 112 by accessing database 122 and databases 136. Search engine 204 may include (or access externally) a data mining tool 206 to mine for pertinent data within databases 122, 136 and other locations within internet 124.

In one example of operation, rule based evaluation engine 202 reads evaluation rules 136 to control operation of search engine 204 and processing of data returned by search engine 204. In another example, search engine 204 utilizes one or more external real estate evaluation services to determine an estimated value of real estate 104 and comparable properties within a certain radius of real estate 104.

Real estate brokers facilitate the origination and completion of real estate transactions and are most often compensated by the seller of real estate. An advantage of system 100, FIG. 1, is that it may enable brokers to become more engaged in the transactional process than the broker in a typical real estate transaction; the brokers may further earn more compensation than that average broker in a traditional real estate transaction. Companies engaged in the business of acquiring and/or developing real estate for investment and/or sale are constantly seeking suitable purchase opportunities. Real estate opportunities often arise on a local basis and are frequently discovered by local real estate brokers. An advantage of system 100, FIG. 1, may enable a development company to enlist local brokers for the purpose of locating suitable purchase opportunities and having brokers optionally assist in the completion of transactions for greater compensation than an average broker would earn on a traditional real estate transaction.

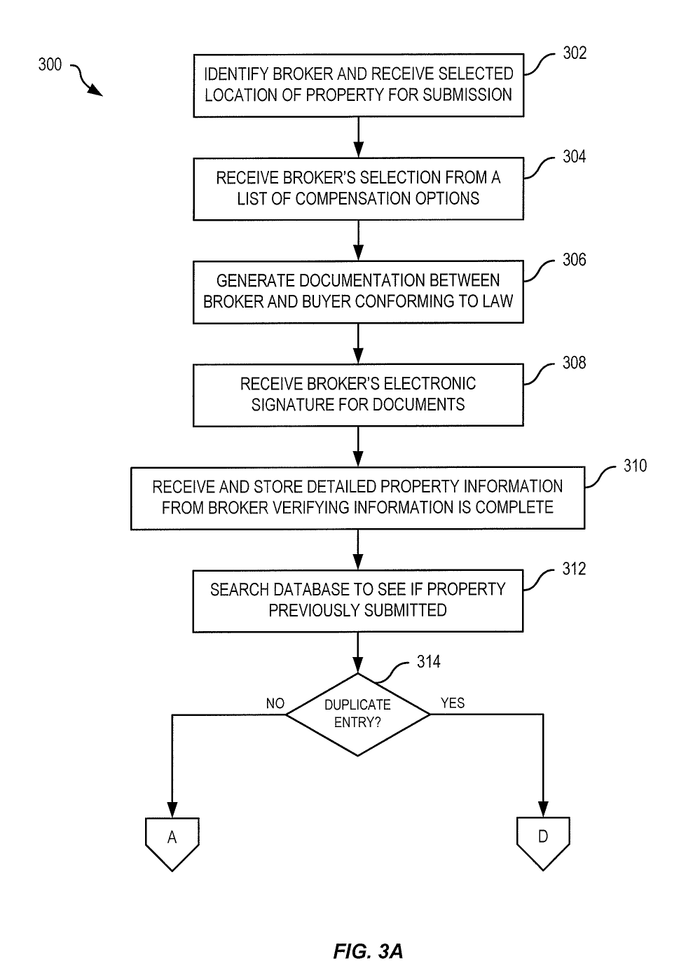

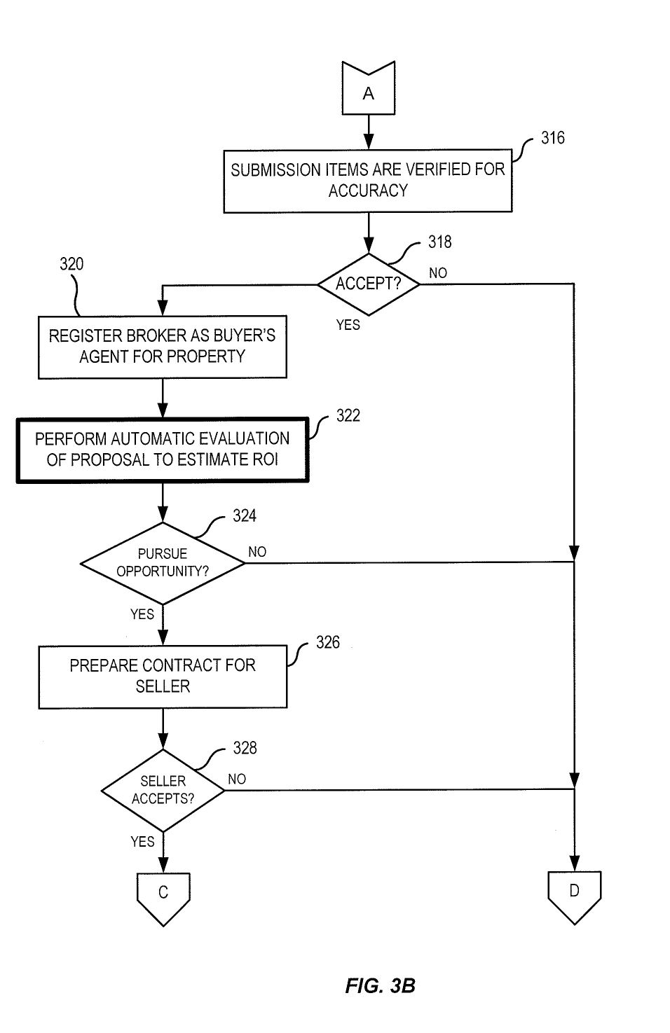

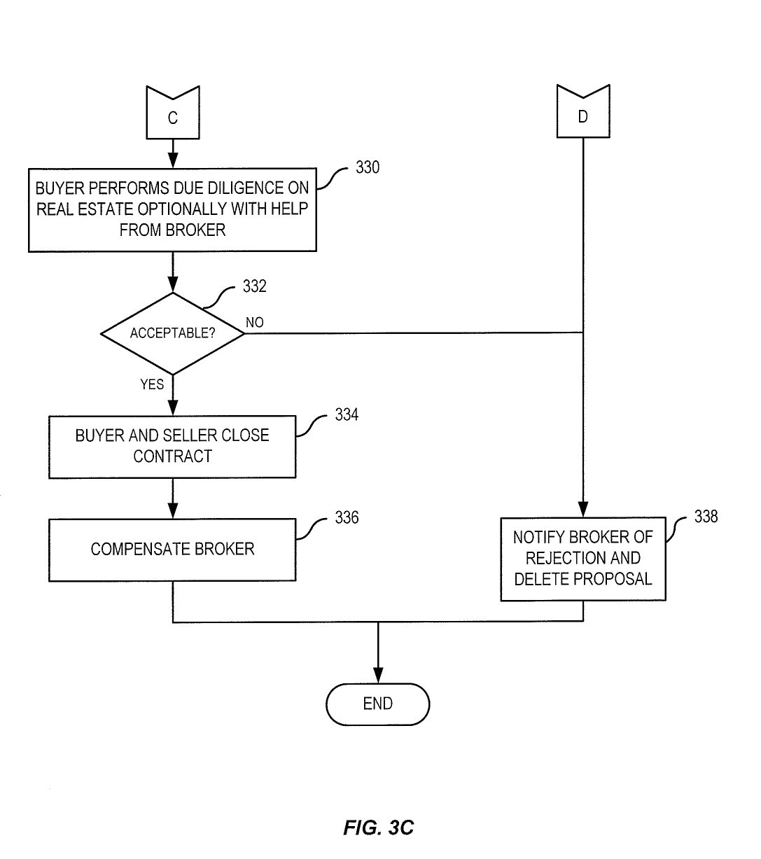

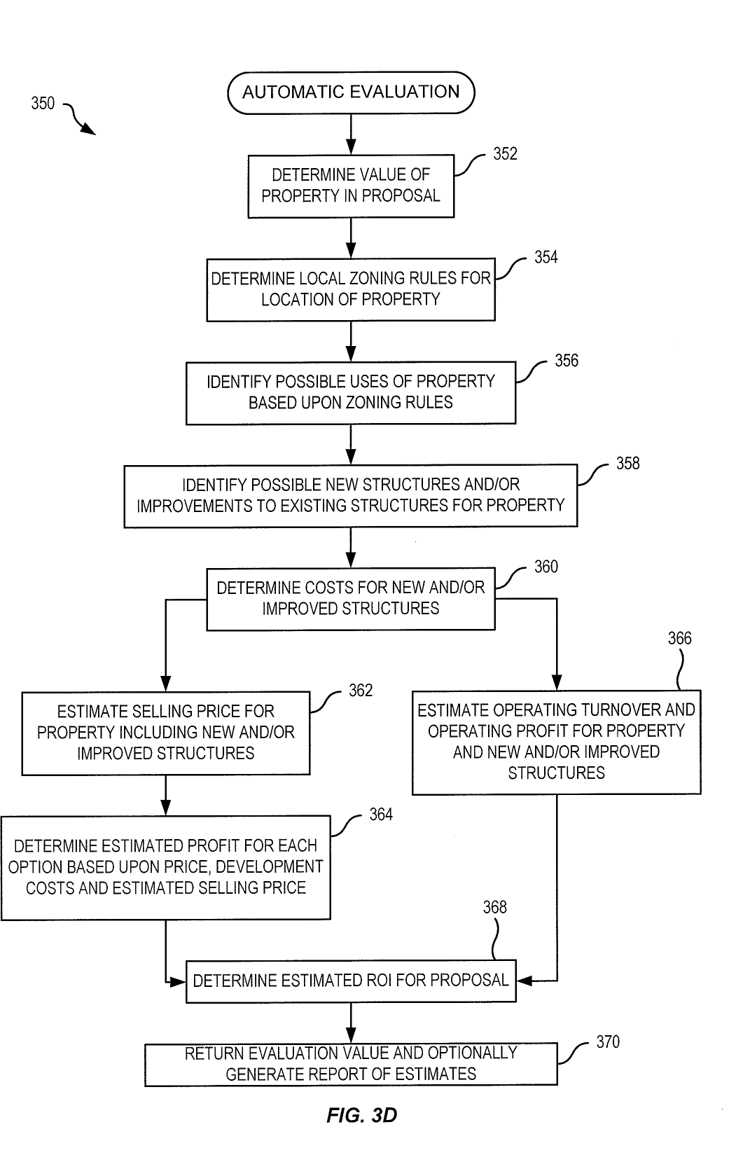

FIGS. 3A-3D show a method 300 for processing real estate opportunities. Steps of method 300 are for example performed, at least in part, by system 100, FIG. 1. FIGS. 1, 2 and 3A-3D are best viewed together with the following description.

In step 302, method 300 identifies a broker interacting with web site 114 and receives a selection of a property location the broker is submitting as an opportunity to the buyer. In one example of step 302, broker 106 logs-in to web site 114 and, by interacting with web site 114, enters information of proposal 112 (i.e., for real estate 104), such as location (e.g., address of real estate 104) and asking price (or estimated transaction value), that broker 106 deems of interest to buyer 132. For example, once broker 106 has logged-in to web site 114, web site 114 may present a web page requesting information of real estate 104 to broker 106; broker 106 then selects and/or enters information into fields of the presented web page and clicks a submit button to send the information to web site 114.

In step 304, method 300 presents, through use of web site 114, a list of compensation options for selection by the broker; the broker indicates a desired compensation option by selecting one of the listed compensation options. In one example of step 304, web site 114 presents a web page that lists available compensation options to broker 106 and broker 106 selects a compensation option from the list. In another example, evaluation module 130 may determine a suitable list of compensation options based upon one or more of previous interactions with broker 106, information submitted in step 302, and prevailing real estate market conditions. Web site host 116 may, for example, store broker 106's compensation selection within database 112 for later use.

In step 306, method 300 generates documentation that conforms to the laws applicable at the location of the real estate and forms a binding contract between the broker and the buyer. In one example of step 306, system 100 generates a contract between broker 106 and buyer 132 based upon the location of real estate 104 as entered in step 302; since broker 106 acts as a buyer's agent for buyer 132, real estate laws applicable at the location of real estate 104 are applicable to broker 106. In one example, the documentation is made available to broker 106 via web site 114; broker 106 may review and print the documentation directly from web site 114 and/or may download the documentation from web site 114 for local review and/or printing. In another example, the documentation is sent via email to broker 106, using contact information entered by broker 106 in step 302.

In step 308, method 300 receives the broker's signature for the generated documents, indicating the broker's acceptance of the terms within the documentation. In one example of step 308, broker 106 reviews the documents generated in step 306 and upon agreement with the terms of the documents, indicates his agreement electronically (for example using an electronic signature) through web site 114. Broker 106 may not proceed further without indicating agreement; non-agreement by the broker means that the real estate submitted by the broker will not be considered in association with the broker.

In step 310, method 300 receives and stores detailed property information from the broker and verifies that the supplied information is complete. In one example of step 310, system 100, through use of web site 114, prompts broker 106 to supply detailed information of real estate 104 and verifies that information is supplied where required. In one example, system 100 presents broker 106 with one or more web pages requesting information of real estate 104 and verifies that broker 106 has entered information into each required field. Optionally, a submit button one of the web pages may not become operable until all required fields have been filled. The broker may be prompted to enter data to empty required fields.

In step 312, method 300 searches a database containing real estate opportunities submitted to system 100 to determine if the real estate opportunity being submitted by the broker has already been registered by another broker. In one example of step 312, evaluation module 130 searches proposal data 123 of database 122 to determine if real estate 104 has been previously submitted.

Step 314 is a decision. If, in step 314, method 300 determines that the property entered in steps 302 and 310 has been previously received, method 300 continues with step 338; otherwise method 300 continues with step 316. In step 338, method 300 notifies the broker that the proposal has been rejected and the information entered by the broker in steps 302 through 310 is deleted.

In step 316, method 300 verifies that items submitted in steps 302-310 are accurate. In one example of step 316, evaluation module 130 verifies the address of real estate 104 entered in step 310.

Step 318 is a decision. If, in step 318, method 300 determines that submitted details are not accurate, method 300 continues with step 338; otherwise method 300 continues with step 320.

In step 320, method 300 registers the broker as the buyer's agent for the property. In one example of step 320, evaluation module 130 stores identification information of broker 106 together with details of proposal 112 (i.e., for real estate 104 as supplied by broker 106) within database 122 within proposal data 123.

In step 322, method 300 invokes an automatic evaluation method 350 to estimate a return on investment (ROI) for the proposed real estate.

In step 352, method 350 determines a value of the real estate of the proposal. In one example of step 352, evaluation module 130 utilizes search engine 204 to determine valuation information of real estate 104 from one or more database entities. For example, search engine 204 may be utilized to search experience data 126 within database 122 for similar properties previously acquired by buyer 132; alternatively research data 128 within database 122 may be searched to identify values of similar properties within a certain radius of real estate 104 previously identified during evaluation of other properties; alternatively a database (e.g., a state office property assessment database) containing information of properties within a local area of real estate 104 may be searched to determine an assessment value of real estate 104 or of similar properties within a certain radius of real estate 104; alternatively a realtor listing may be searched to determine prices of similar properties within a certain radius of real estate 104. Based upon the one or more determined values, a value of real estate 104 may be estimated. Alternatively, if values of similar properties are not available, an operative may be dispatched by the buyer to research information of the area and populate research data 128 with information pertaining to real estate 104 and similar properties within a certain radius of real estate 104. Evaluation rules (e.g., from evaluation rules 129 of database 122) may be applied during the estimating of a value of real estate 104 to improve accuracy and/or trust in the estimated value. These rules may prioritize data and its use when determining an estimated value of real estate 104.

In step 354, method 350 determines local zoning rules that apply to real estate 104. In one example of step 354, evaluation module 130 may utilize search engine 204 to process experience data 126 and/or research data 128 to identify zoning rules applicable to real estate 104.

In step 356, method 350 identifies possible uses of the real estate based upon zoning rules. In one example of step 356, evaluation tool 130 identifies possible uses of real estate 104 by searching for properties with similar zoning rules within experience data 126. In another example, evaluation tool 130 utilizes evaluation rules 129 to identify uses of real estate 104; evaluation rules 129 may, for example contain table like structures listing possible property uses based upon zoning rules.

In step 358, method 350 identifies options for developing new structures and/or improving existing structures upon the real estate based upon identified uses of the real estate. In one example of step 358, evaluation tool 130 identifies possible structure types suitable for each use of real estate 104 identified in step 356. For example, evaluation tool 130 may determine that a hotel or a refueling station may be constructed upon real estate 104 based upon determined zoning rules of real estate 104.

In step 360, method 350 determines an estimated cost for construction of new and/or improved structures identified in step 358. In one example of step 360, evaluation tool 130 utilizes information of experience data 126 to determine approximate construction costs for a hotel to be constructed on real estate 104 and also construction costs for a refueling station to be constructed on real estate 104.

From step 360, method 350 has two concurrent paths depending upon desired outcome of the real estate transaction. Steps 362 and 364 are utilized to determine a selling price and profit for each use of the real estate and for each structural development option determined in steps 356 and 358. Step 366, method 350 estimates operating turnover and operating profit for each identified use of the real estate for each structural improvement identified.

In step 368, method 350 determines an estimated return on investment for each identified use and/or each identified structural development option evaluated in step 356-366. For example, based upon asking price for real estate 104, development costs for real estate 104 and estimated final selling price of real estate 104 (including new and/or improved structures) a profit is estimated for each option.

In step 370, method 350 returns an evaluation value to the calling method. In one example of step 370, one or more evaluation rules of evaluation rules 129 are utilized to determine an optimal development scenario (e.g., construct new hotel and then sell to realize profit of $5M) for real estate 104, which is returned to the calling method.

Step 324 of method 300 is a decision. If, in step 324, it is determined that a sufficient profit may be realized from the acquisition of the real estate accepted in step 318, method 300 continues with step 326; otherwise (e.g., no development options were estimated to return sufficient profit) method 300 continues with step 338.

In step 326, method 300 prepares a contract for the seller of the real estate. In one example of step 326, evaluation module 130 prepares a contract for sale of real estate 104 for seller 102.

Step 328 is a decision. If, in step 328, method 300 determines that the seller has accepted the contract, method 300 continues with step 330; otherwise method 300 continues with step 338. For example, based upon asking price and estimated return on investment, the contract may be prepared with a buying price less than the asking price.

In step 330, method 300 performs due diligence on the real estate; optionally the broker may be enlisted to help with this due diligence as necessary. In one example of step 330, evaluation module 130 utilizes evaluation rules 129 and search engine 204 to identify certain information relating to real estate 104 and utilizes web site 114 to interact with broker 104 to obtain certain other information.

Step 332 is a decision. If, in step 332, method 300 determines that the due diligence performed in step 330 is acceptable, method 300 continues with step 334; otherwise method 300 continues with step 338. In one example of step 332, evaluation module 130 obtains sufficient information from search engine 204 and broker 106 and buyer 132 to determine that sufficient due diligence has been performed and that buyer 132 should close on the real estate 104.

In step 334, the buyer and the seller cooperate to close the contract. In one example of step 334, buyer 132 and seller 102 sign the contract, prepared in step 326, and the buyer transfers the agreed funds to the seller.

In step 336, the buyer compensates the broker as requested by the broker in step 304. In one example of step 336, buyer 132 provides a contract to broker 106 entitling broker 106 to ten percent of the profits realized from real estate 104.

The listed steps of method 300 may occur in another order without departing from the scope hereof.

Evaluation Rules

A real estate opportunity (e.g., real estate 104) may be identified by its address (hereinafter called LOCATION), which is entered by a broker (e.g., broker 106) when submitting the real estate to a buyer (e.g., buyer 132) via the buyer's web site (e.g., web site 114). The broker may supply other facts of the proposal, such as an area of the land associated with the real estate (hereinafter called AREA). System 100 may automatically search for prices of similar properties that are local to the real estate opportunity. For example, a rule may be created and stored within evaluation rules 129 that initiates a search to identify all properties similar to the real estate of the proposal that is within a 10 mile radius of the specified LOCATION based upon the address and characteristics of the proposed real estate. Illustratively, one exemplary rule may state: find properties within a 10 mile radius of LOCATION with an area within 10% of AREA. Databases (e.g., databases 136, FIG. 1, such as MLIS databases) are searched and/or information is provided by the Broker at log in (e.g., web site 114 requires that the broker enter information about similar property evaluations within a certain are of the proposed property). Another exemplary rule may state: find an assessed value of LOCATION. In this example, system 100 searches local state or governmental office databases to determine a value of real estate 104 based upon tax assessments. Thus, a first order valuation (hereinafter VALUE-1) of the property in the proposal is determined. Rules may be defined that utilizes these determined values to evaluate the seller's asking price (hereinafter PRICE) for real estate 104. For example, a rule may compare VALUE-1 to lower and upper limits for desired transactions by buyer 132. Another rule may compare VALUE-1 to PRICE and require that PRICE is within, e.g., 30% of VALUE-1.

Based upon LOCATION, local zoning rules (hereinafter ZONING) for the area may be determined from databases (even from law firms or TriStar experience data in server 118). Zoning rules for the location may limit the possible uses (hereinafter USE) of the property and thus the types of structure (hereinafter STRUCTURE) that may be developed on the property (e.g., gas station, hotel, office development, shopping mall, etc.) Based upon the ZONING, possible uses of the property and possible structures that may be developed upon the property may be determined. Based upon the STRUCTURE to be developed, a development costs (hereinafter DEVCOSTS) for constructing and/or improving any existing structure may be estimated. For example, DEVCOSTS may be determined using a database of previous projects (e.g., experience data 126) with similar criteria and by applying a weighting based upon the LOCATION. Experience data 126 may be constructed using experience obtained during development projects executed by buyer 132. Similarly, research data 128 may be built from details researched locally by Broker 106. Optionally, from experience data 126 and/or research data 128, a development cost return on investment (hereinafter DRETURN) may be estimated. Rules may therefore be developed and stored within evaluation rules 129 to identify properties that present good and/or bad opportunities.

Rules may also be developed for estimating the selling price (hereinafter SALEPRICE) of the property including any STRUCTURE based upon the intended USE of the property. For example, one rule may specify that experience data 126 is used to find properties with similar developments and that any determined value is adjusted for LOCATION. Optionally, Broker 106 may be asked to provide examples of similar property transactions within a certain radius of LOCATION within the last year. These may be added to research data 128 to allow automatic processing of proposal 112.

Thus, from the determined parameters of proposal 112, and information resulting from searching one or more databases, system 100 may iterate through many permutations of possible USEs, STRUCTREs, DEVCOSTS, DRETURNs and SALEPRICEs, based upon ZONING, to determine resulting profits (hereinafter PROFIT) expected from proposal 112. Other factors may be included (e.g., Broker compensation) without departing from the scope hereof. Thus system 100 may determine estimated returns for all development options for proposal 112, and thereby determine if proposal 112 is suitable for buyer 132.

As additional data is collected (i.e., stored within experience data 126 and research data 128), system 100 will improve its accuracy of predicted profit. Further, rules may be added to evaluation rules 129 to also improve accuracy of estimated profit and/or provide better indication of suitable proposals. System 100 may effectively operate as a type of expert system, applying experience and data stored in a plurality of databases to rules that identify good or not-so-good opportunities presented by Brokers.

Where or when title information is available within a database, an initial level of due diligence may also be performed automatically to identify legal conflicts and loans/leans upon the property.

Rules can be applied to the values that may limit searching. For example, where development costs are high and the development return is small for a certain area, the USE of the property may be restricted. Examples of simple rules are:

SALEPRICE>PRICE+30%

PROFIT>1,000,000

Complex rules may be applied where, for a shopping center development, for example, the acquired property will not be sold but will be operated to return a profit. In which case, operating data based upon LOCATION and STRUCTURE may be obtained to estimate a yearly operating profit (hereinafter OPROFIT).

Other information may also be applied, based upon USE and LOCATION, to determine desirability of a particular use. For example, there is no point building a hotel that is not near sufficient businesses, since there may not be sufficient trade for the hotel. Thus, searches for other property types within the area and that relate to a possible USE may be performed. This type of search may be based upon the ZIP code of the LOCATION, for example. Where data is not available for a LOCATION, system 100 may notify buyer 132 thereby allowing an operative to be deployed to research the area (and then populate research data 128 to allow automated searches to proceed). Alternatively, a questionnaire may be sent to the Broker to request that the Broker researches certain areas.

A broker rating system may be maintained by system 100, whereby a Broker is rated based upon accuracy of researches performed; that is, a trust level of the Broker may determine the level of trust in the provided data. Broker interaction with system 100 may be enabled through forms presented to the Broker on website 114, such that these forms interactively steer the Broker to required research to acquire missing information within experience data 126 and research data 128. Accordingly, system 100 may have determined certain information through the Internet or other sources, and thus only requires partial results to be determined by the Broker.

By processed parameters such as PRICE, DEVCOSTS and PROFIT for each possible USE of real estate 104, system 100 may automatically determine if proposal 1 12 is attractive to buyer 132, since buyer 132 creates rules to identify such proposals.

As more information regarding a proposal becomes available, required parameters (constraints) are tightened such that the estimated return on investment from the proposal becomes more accurate, and undesirable proposals are rejected. For example, if an initial evaluation of a proposal indicated that it may be of interest to buyer 132, additional rules may be applied to tighten constraints, thereby increasing the likelihood that the proposal would be accepted, or not, by buyer 132.

For example, an initial valuation may determine how PRICE compares to prices of similar properties in the locality of LOCATION. Although this is initially rough (i.e., certain assumptions are made), additional rules may be applied (e.g., evaluation of zoning based upon other facilities within a certain radius of LOCATION) to determine a best use of a proposed property. In one example, Broker 106 may suggest a suitable use for real estate 104. Another rule may evaluate available utilities to the property, comparing these utilities when comparing similar properties, thereby ruling out USEs that are not feasible.

Databases of zoning, pricing, restrictions, etc., can be stored or searched automatically (and/or provided by broker when proposing a deal). This information is then factored into an algorithm (e.g., a least squares algorithm with appropriate weights) to “tighten” a decision tree outcome.

OUTCOME=SQRT[(pricing weight)*EXPECTED GAIN’+ . . . ].

Where a Broker submits a proposal for an area of undeveloped land, the broker may suggest a possible USE for the land. Evaluation module 130 may then evaluate this suggested USE as well as all other possible USEs (e.g., office space, shopping mall, gas, etc.), based upon ZONING, to sequentially examine (automatically) and determine which OUTCOME is optimal.

Where it is expected that zoning rules may change for the property, the ZONING may be widened to allow more possible USEs, thereby assessing each possible development opportunity. In one example, a probability may be applied to a LOCATION as to whether zoning may change; this probability may then be factored into the possible OUTCOME.

For each USE, an INVESTMENT amount is determined (or entered by the buyer, for example) so that PRICE+INVESTMENT is examined when determining an ROI for the proposal. The best ROI may be chosen.

Referring again to FIG. 1, web site 114 is designed to be licensed by real estate companies to improve their ability to do business with real estate brokers for the purpose of finding and completing acquisitions. Brokers approach companies via companies' web sites and register properties for companies to consider acquiring. After registration, brokers may assist at a local level in the investigation, evaluation and finalization of property acquisitions. Brokers choose their compensation plan from a menu that may include compensation from the buyer, seller or both.

In an embodiment, Brokers submit properties via these companies' web site and companies subsequently purchase registered properties, the following steps may occur: Brokers submit a property on the “register a property” pages of the Broker Log-in along with required property information; all contract documents between Brokers and companies related to registered properties are approved by Brokers as part of property submission; companies approve submissions as registrations as long as the information submitted is complete and accurate and properties being submitted have not already been registered; once properties are registered, companies request any additional information needed to make a final determination about whether companies will pursue acquisition of properties; when companies decide to pursue registered properties, they prepare contracts to be presented to sellers; when sellers accept contracts, companies perform in-depth due diligence and may request the assistance of Brokers that registered the properties; if due diligence is satisfactory, then companies close the purchase of registered properties and Brokers receive any cash commissions due at closing; Brokers that elect to receive participatory interests from companies that offer participatory interests will receive their participatory compensation after closing.

The totality of company/broker interaction using website 114 differs from traditional real estate transactions. Some of these differences are outlined below.

Real Estate Investment and Development Companies

Commercial property companies constantly seek acquisition opportunities with sufficient economic upside. Companies are limited in this effort because opportunities arise in many markets where companies are unfamiliar with local market conditions and where companies do not have local representatives to help them process transactions.

Companies may overcome these limitations by using website 1 14 to receive property registrations from brokers in certain markets. As part of the registration process, brokers submit detailed information on specific properties that brokers believe to have good economic potential. Brokers that register properties become companies' exclusive buyers' agents for those properties.

Before submissions are accepted as registrations, website 114 automatically scans companies' registered property databases to verify that properties being submitted for registration have not been previously registered by another broker. Submissions are automatically accepted as registrations if properties are clearly identified, all property information is complete and accurate, and the property being submitted has not been previously registered. Duplicate submissions or submissions that are incomplete or inaccurate will be declined. Brokers' confidential property information is protected regardless of whether the submission is accepted as a registration.

After registration, brokers may utilize their local market knowledge and connections to help effectuate transactions. This differs from the traditional procedure in which brokers act primarily as sales agents and do not become deeply involved in buyers' evaluation or development efforts. Website 114 thus allows companies to create distributed, contingency-based workforces by providing incentives to brokers in the form of substantial buyers' agents' compensation in a predictable and systematic way.

Web site procedures may be adjusted to fit the business styles of the real estate companies that license them. Among these adjustable procedures are: type of participants allowed to register properties (e.g. licensed real estate person, attorney, property owner); compensation programs that brokers may choose among, which may include compensation from seller, buyer or both; compensation from buyer may be in the form of cash commissions, a participatory interest or a blend of the two; participatory interests may be in the form of an ownership interest or profit interest; types of real estate that may be registered; amount of information required with initial property submission; degree of assistance, if any, required from broker after registration.

There exist internet-based real estate listing services that allow buyers access to listed real estate on a national basis, most notably Co-Star and LoopNet. But these websites only serve to make potential buyers aware of listed real estate and supply the listing broker's contact information. Unlike the website 114, these web sites are not integrated systems for transacting business.

In the past, real estate sales commissions are usually paid to Brokers by sellers of properties. Brokers that produce buyers for properties that are listed by other brokers have little control over the level of sales commission they are paid. Buyers' brokers usually negotiate with listing Brokers to obtain shares of listing Brokers' commissions.

Website 114 allows brokers to choose from a menu of compensation options when they register a property. One of the options may allow brokers to obtain all or a large part of their compensation from the companies on whose web sites brokers register properties, if those registered properties are subsequently purchased by companies receiving the registrations. Choosing among compensation options allows brokers to tailor their compensation programs to circumstances of individual transactions to maximize their income, within the framework of their ethical and fiduciary duties. Compensation paid by companies utilizing website 114 may be in the form of participatory interests in the property being acquired, providing another form of incentive for brokers to engage in business with companies utilizing web sites.

In the real estate business, website 114 targets brokers instead of other types of business people (such as real estate developers) because, for the most part, brokers are the licensed persons or entities authorized to assist in the sale of real estate in most states of the United States. Real estate brokerage laws vary from country to country and state to state. Website 114 may thus automatically generate contract documents between companies and brokers that are customized to local laws and regulations.

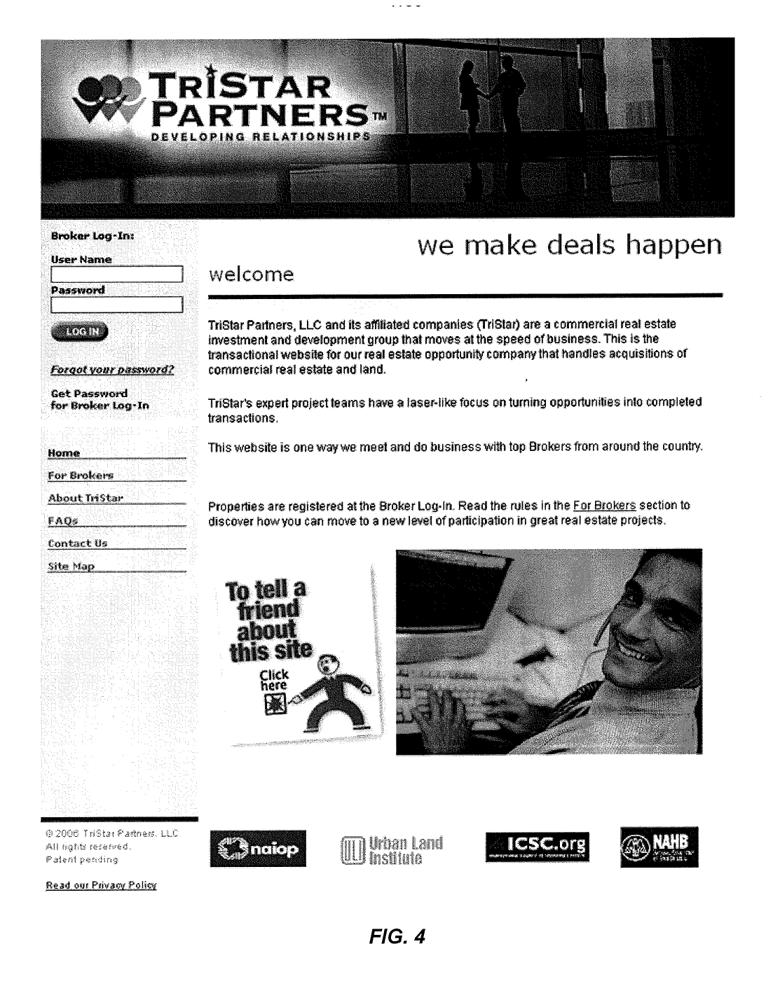

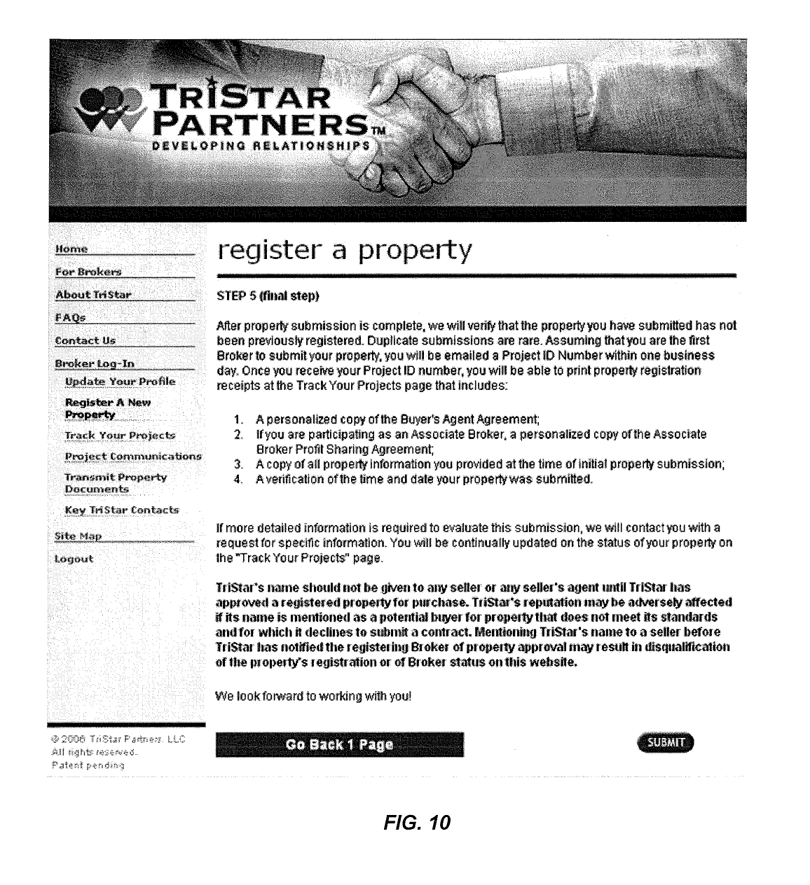

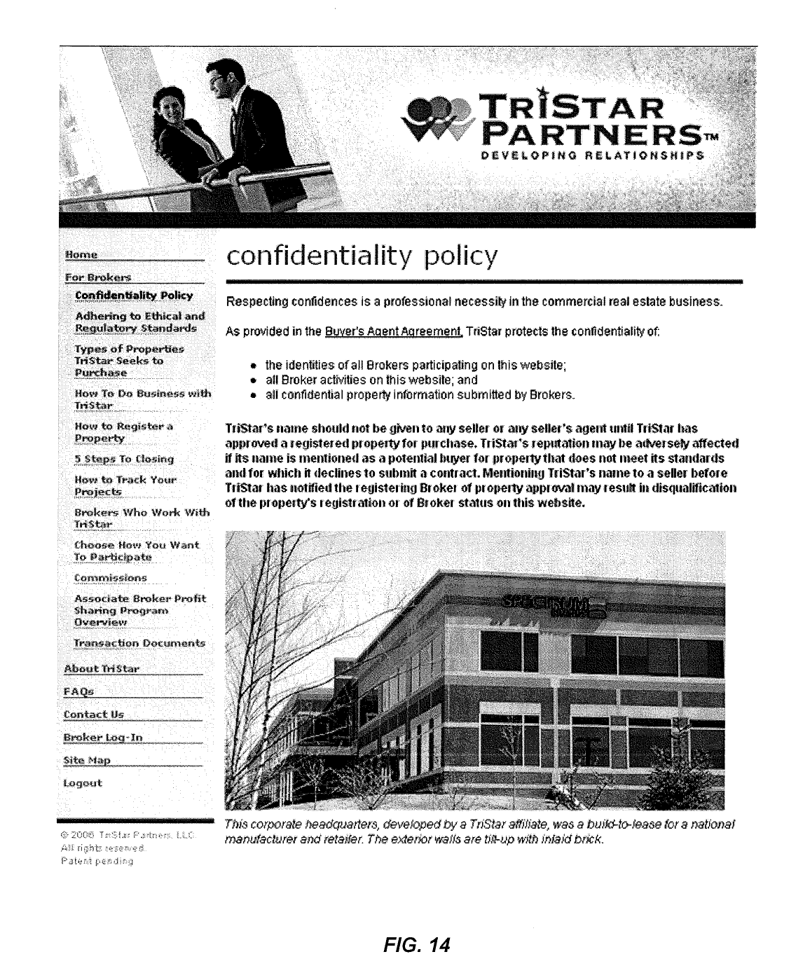

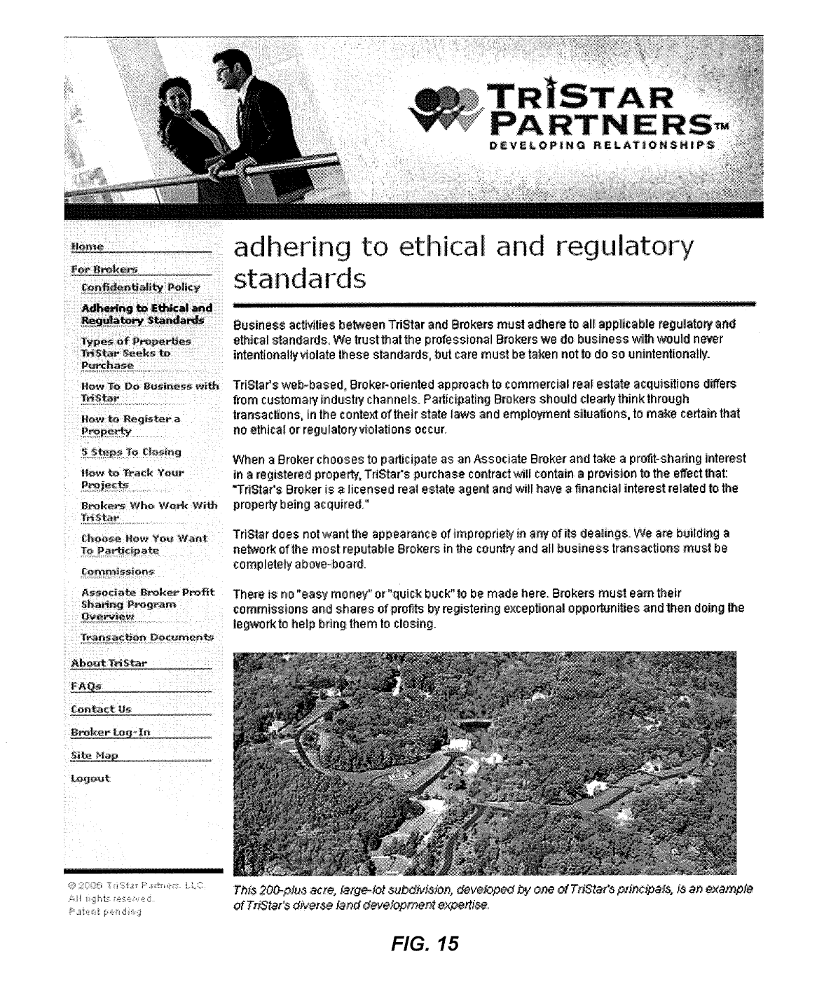

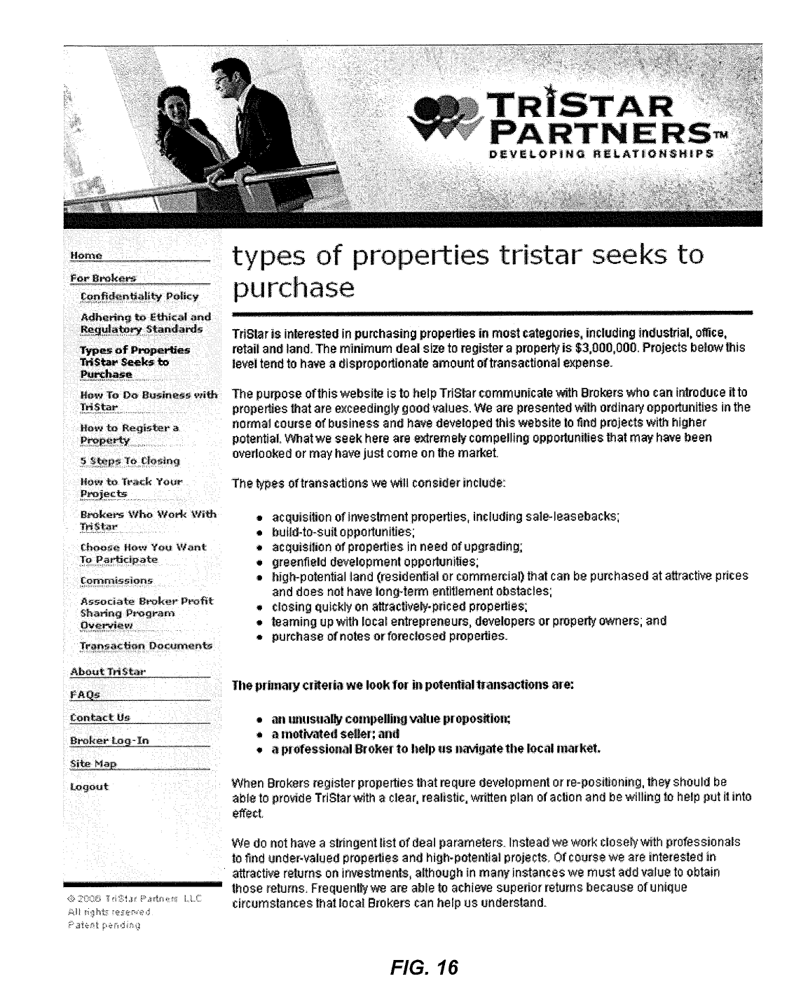

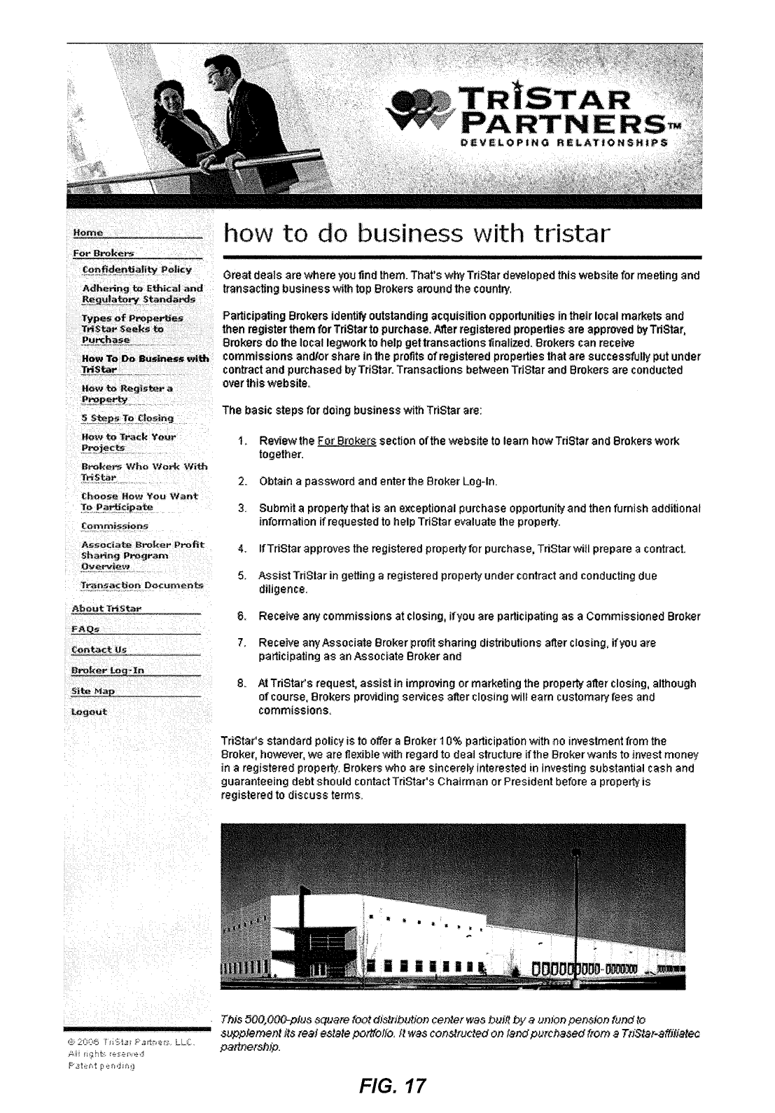

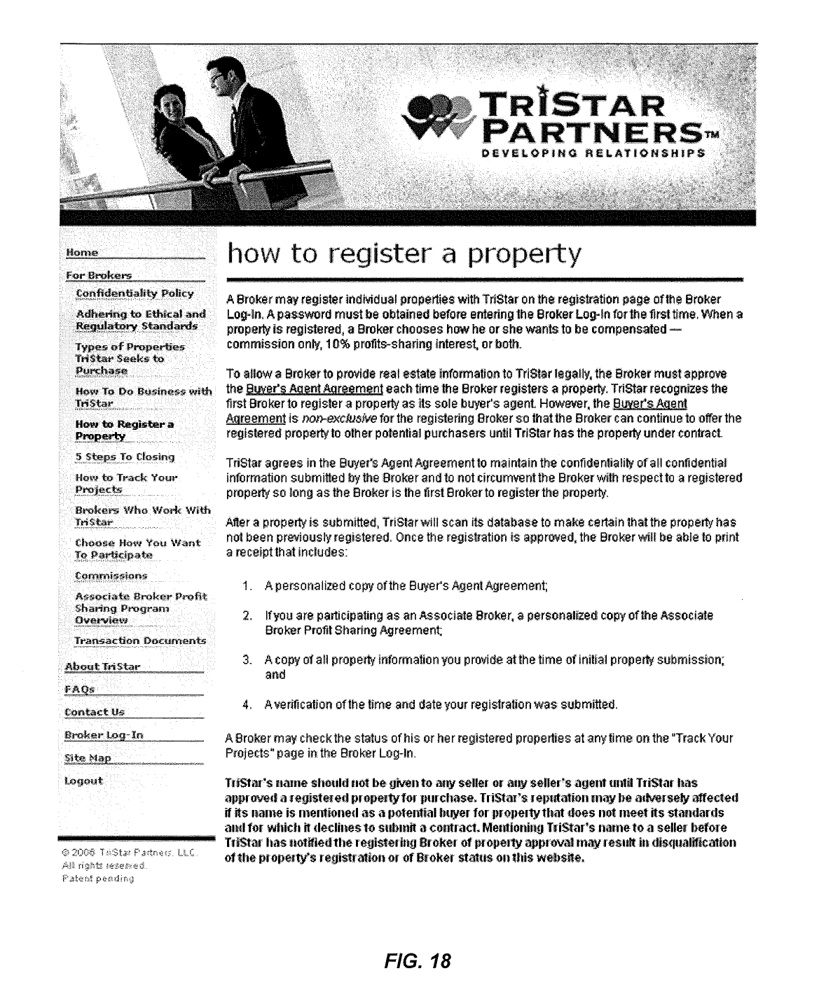

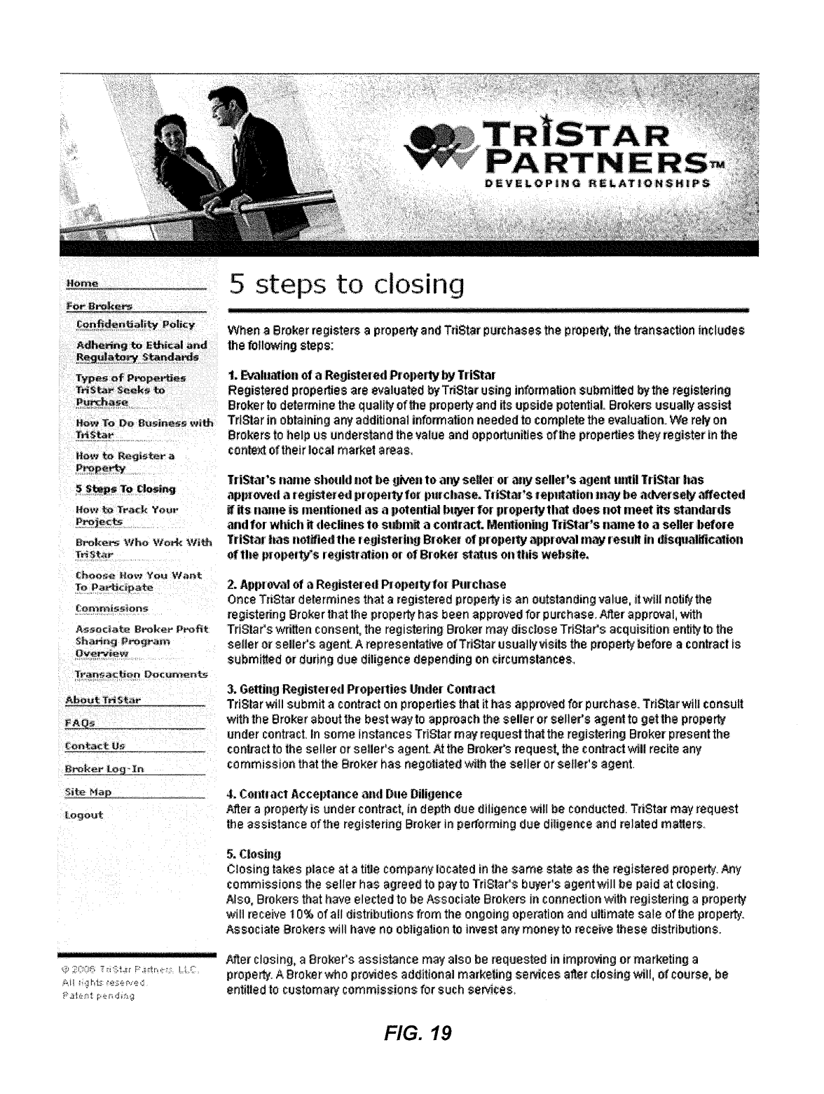

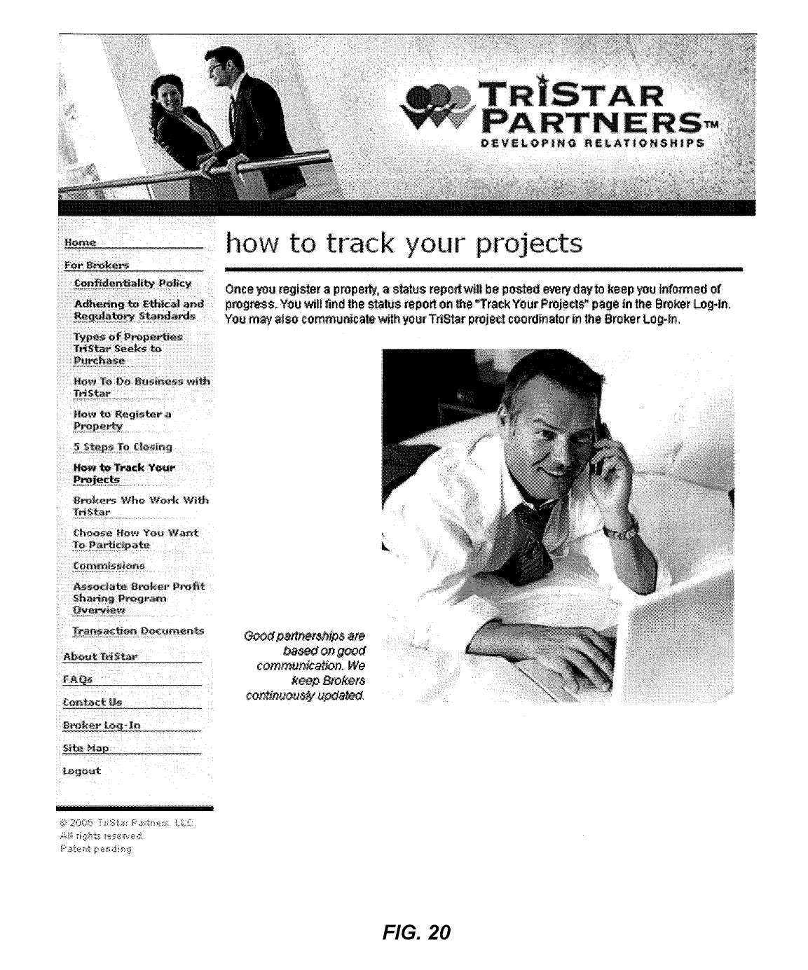

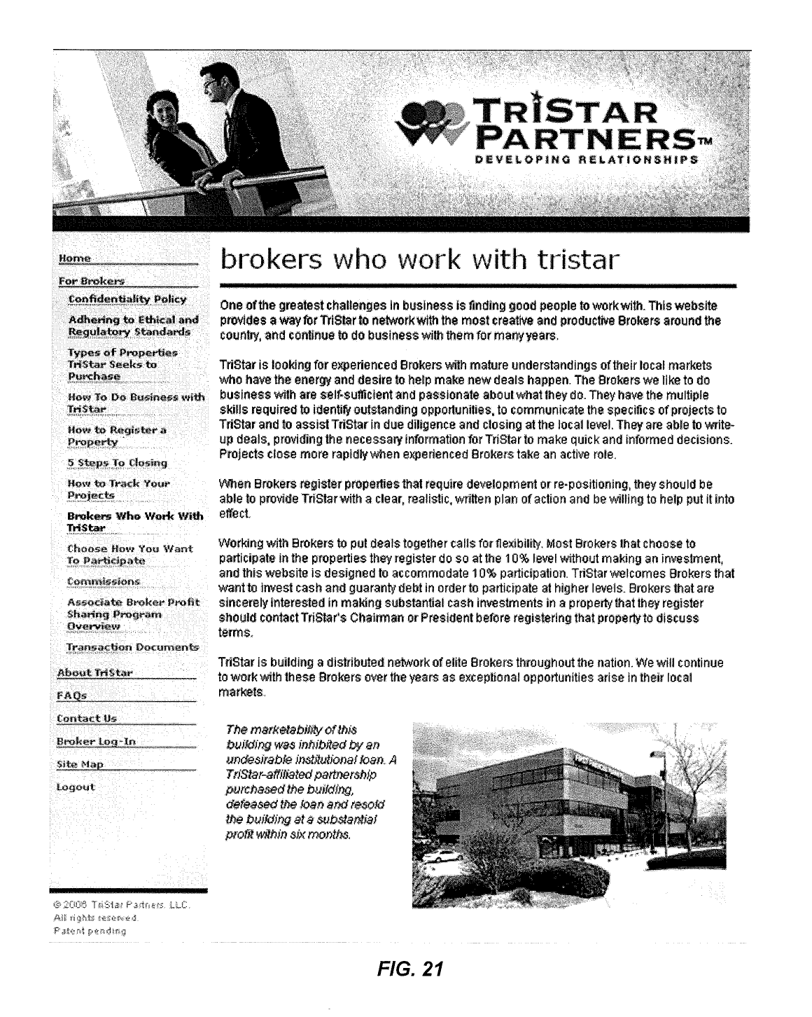

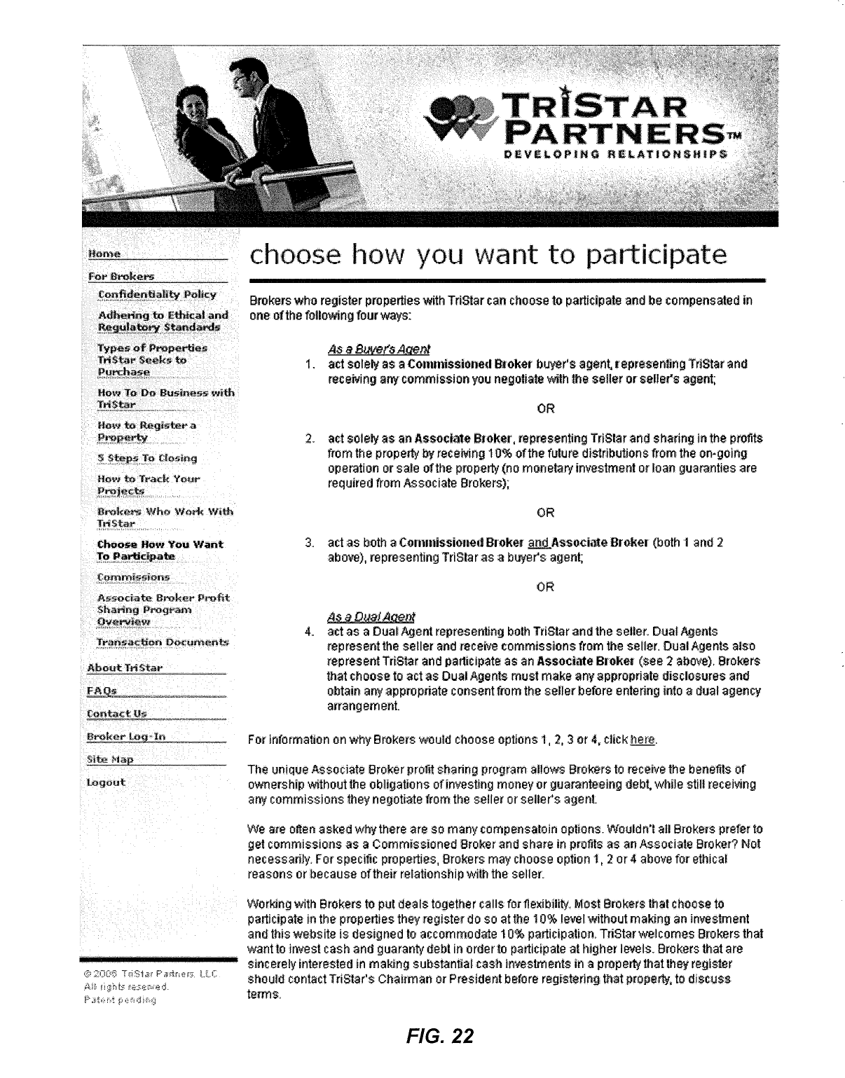

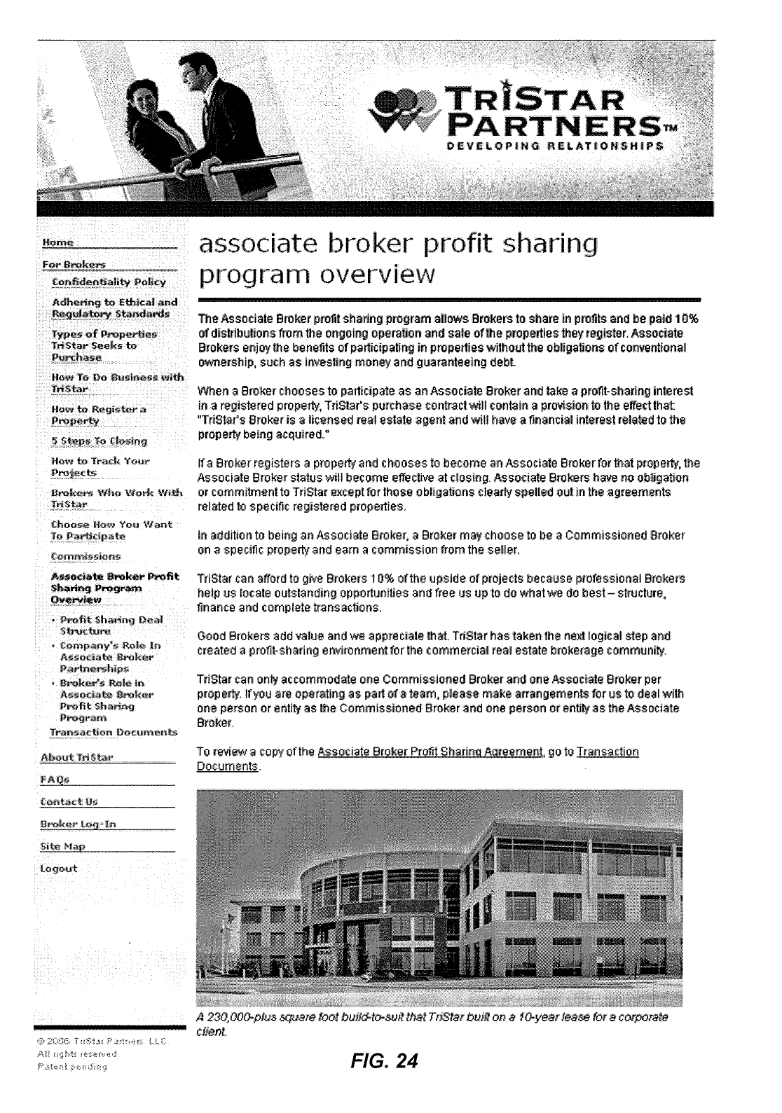

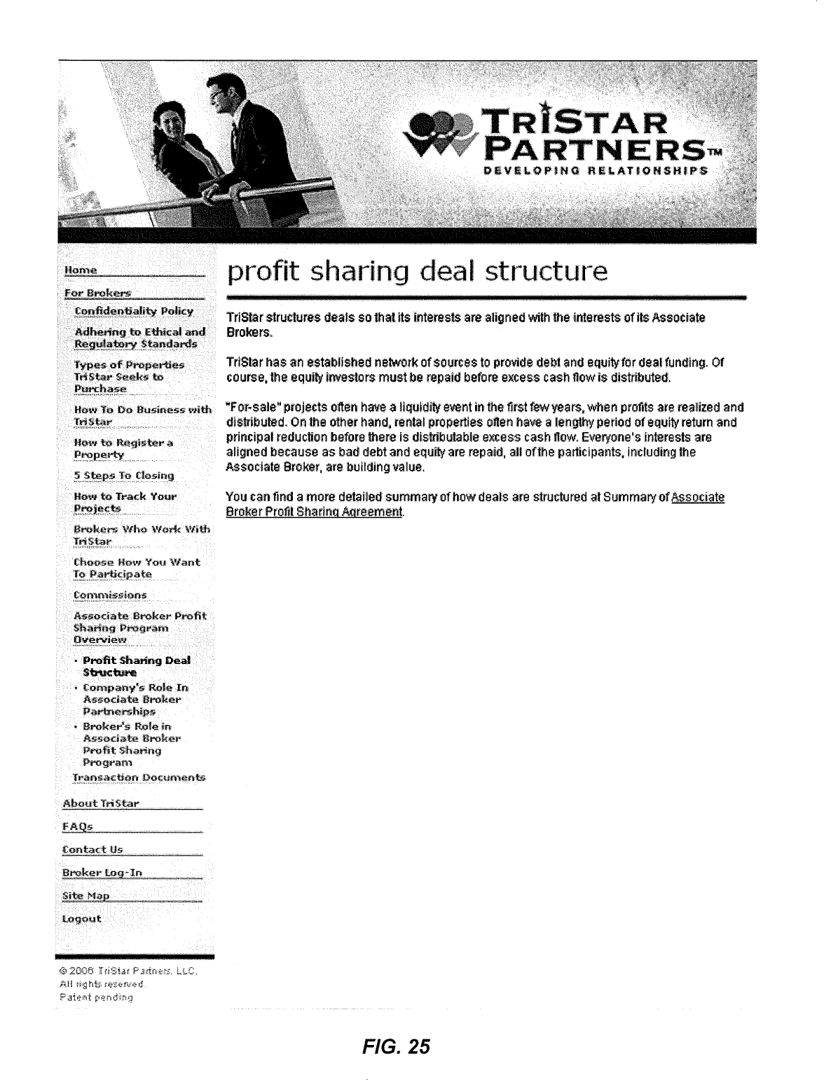

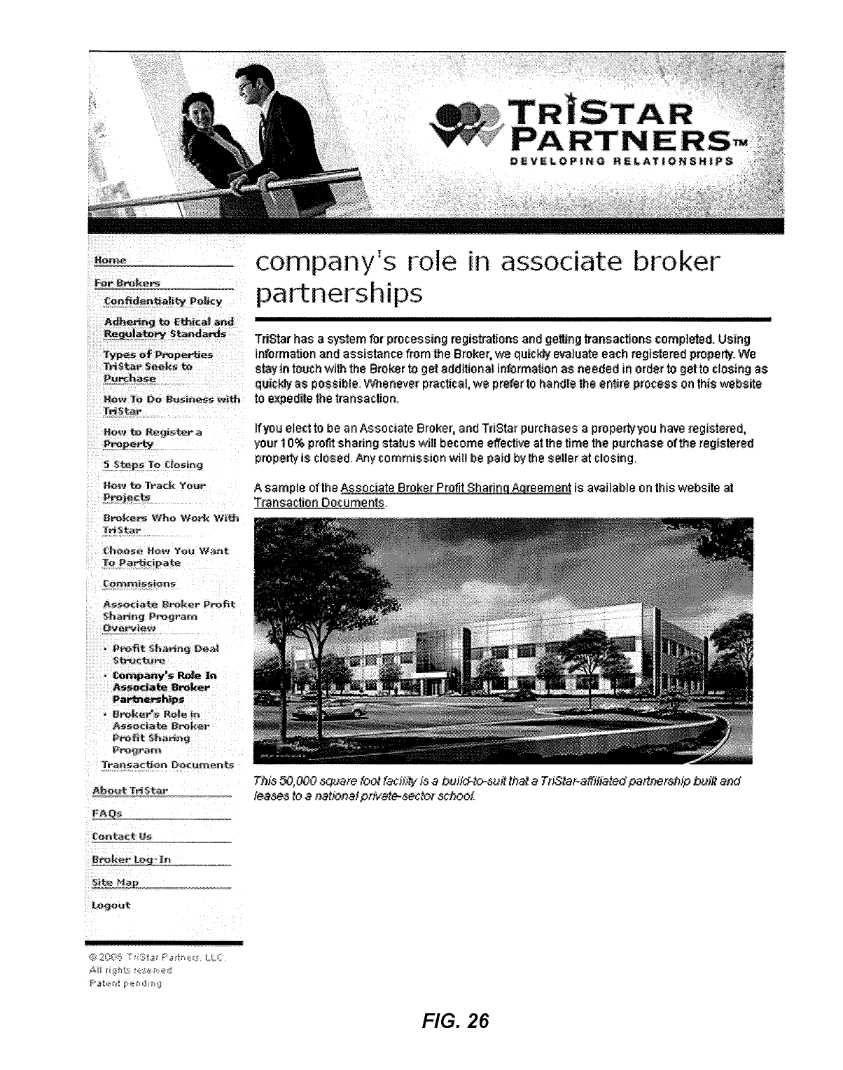

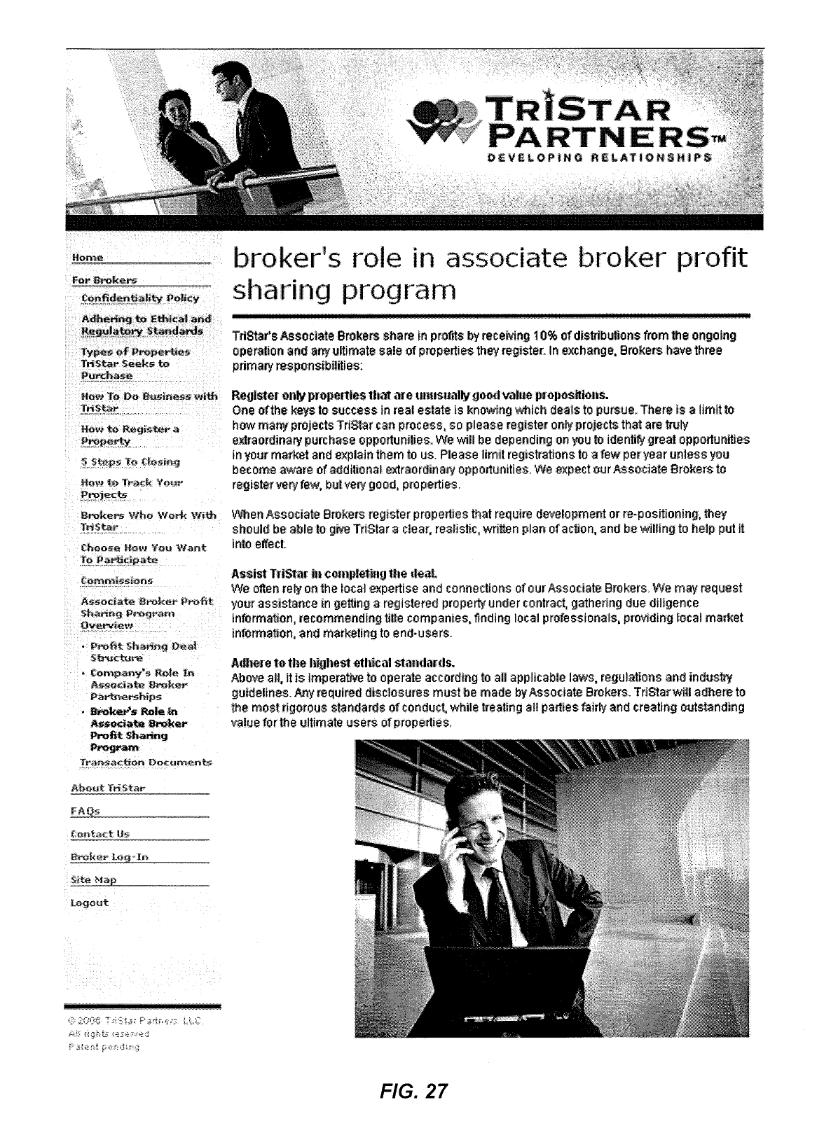

FIGS. 4-29D show exemplary web pages for processing real estate opportunities. In one example, web pages of FIGS. 4-29D may represent web pages generated by web site host 116, FIG. 1, for web site 114.

The embodiment illustrated in FIGS. 4-29D illustrate a website 114 composed of separate web pages accessible via a computer network (e.g., Internet 124). The computer network for this particular embodiment is the World Wide Web. In other embodiments, the broker may access the website through another computer network, considered an internet or an intranet.

FIG. 4 is a webpage for the pre-registered broker to be logged into the website. The broker is required to enter a User Name and Password given or set by the broker at registration.

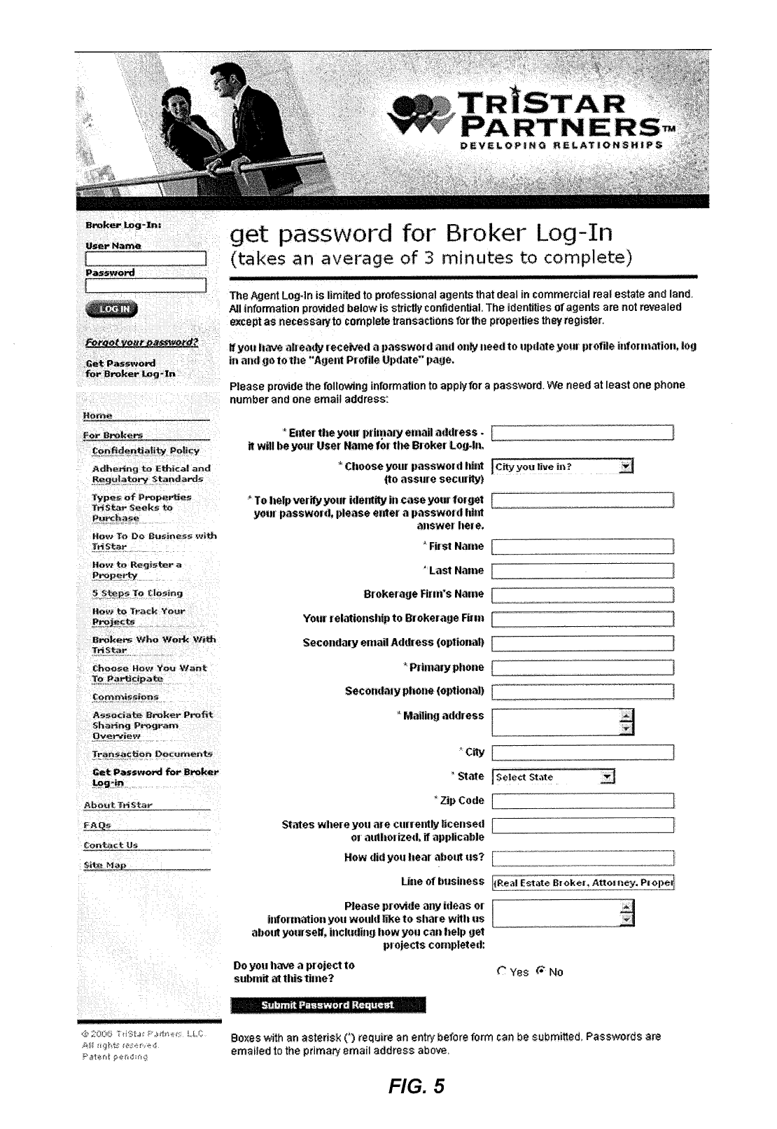

FIG. 5 is a webpage for registering the broker. In this particular embodiment, the broker enters the broker's identification and contact information. The broker is also prompted to input information related to the states in which the broker is licensed and the area of field of practice in which he or she is licensed. In other embodiments, registration may require or request more, less or different information than that outlined in the embodiment of FIG. 5.

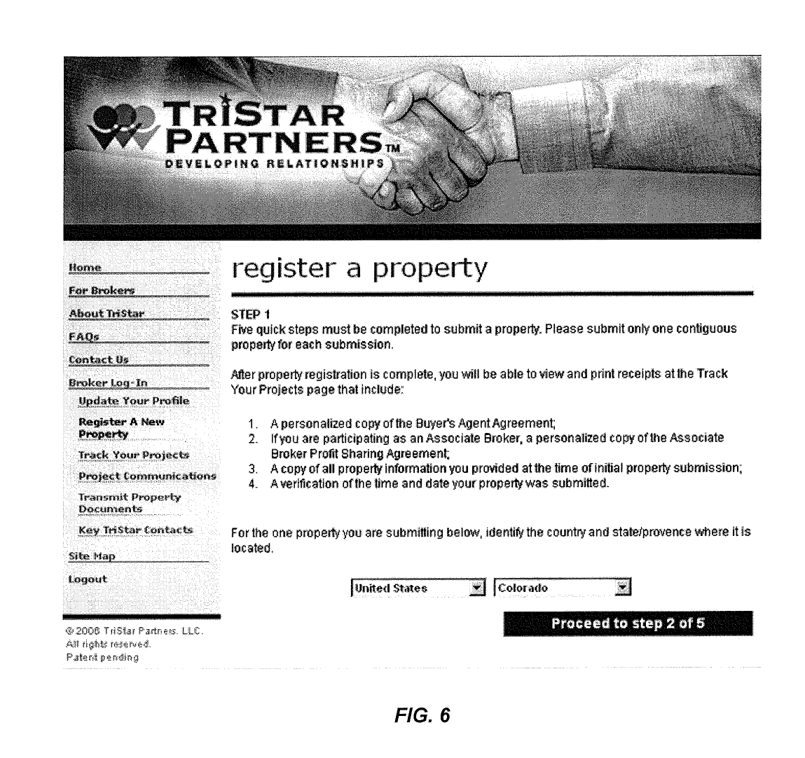

Once the broker has registered and enters the website, the broker is able to access other web pages related to submitting real estate proposals. As illustrated in FIG. 6, the broker is prompted to enter limited identification information. This limited identification information includes the territory in which real estate included in the real estate proposal is located. The precision of the territorial disclosure may be set by the receiver or by territorial law.

In one embodiment, the state and country of the real estate is necessary to form an agency agreement between the broker and the receiver. Since real estate laws vary from state to state in the United States, the inclusion and exclusion of terms and conditions in the agreement will change with the selection of the territory. The requirement of a larger territorial selection is preferred by the broker, because it limits the information submitted by the broker until an agreement is formed between the receiver and the broker. In other embodiments, the broker may be prompted to select a broader or narrower territory in which either real estate included in the real estate proposal or the broker is located.

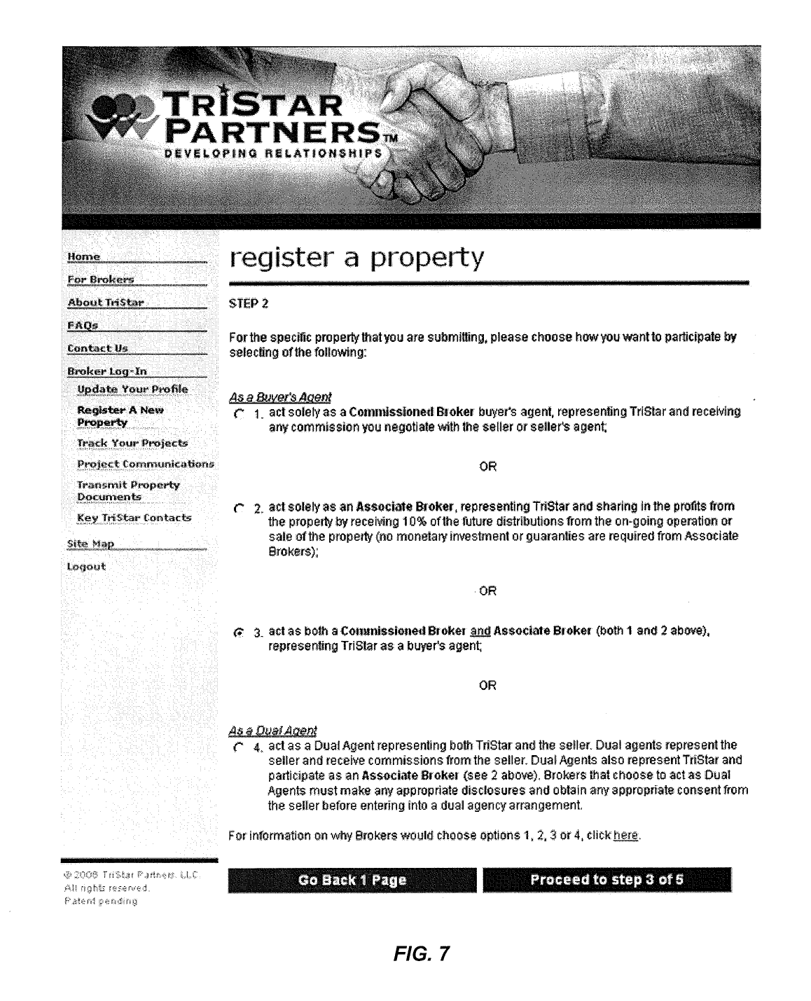

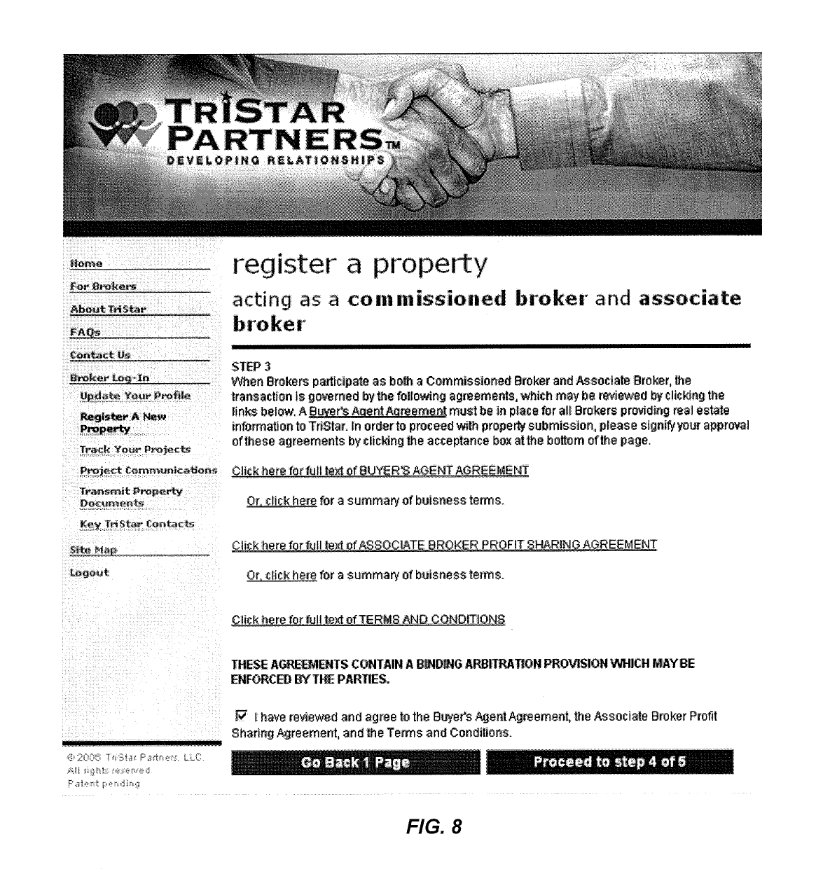

The receiver also receives the broker's selection of basis of compensation. As states above, the broker may have several options including an interest in the real estate proposal, a commission or a combination of the interest and the commission. As illustrated in the embodiment of FIG. 7, the broker is offered one of a participatory interest, a commission, and a combination of the participatory interest and the commission. The broker is prompted to select one of these options to proceed.

The broker may be obligated to select one form of compensation over another due to previously formed relationships. For example, if the broker already represents real estate included in the real estate proposal for another client, a conflict of interest arises. The conflict arises for the broker between the broker's potential interest in the subject matter of the real estate proposal and the client's interest in the real estate. This situation may necessitate the broker to select a basis of compensation which does not include an interest in order to avoid breaching a fiduciary duty owed to the broker's previous client. This consideration and others factor into the broker's selection of a basis for compensation.

The territory information and selection of a basis of compensation are then used to generate an agency agreement between the receiver and the broker. The agency agreement consists of terms and conditions dictated by the territory law of the real estate included in the real estate proposal and the selection of the basis of compensation. As illustrated in FIG. 8, the agency agreement is available for review via the computer network. The broker is expected to review and accept the terms and conditions of the agency agreement. In this embodiment, acceptance of the agency agreement is required to submit a real estate proposal.

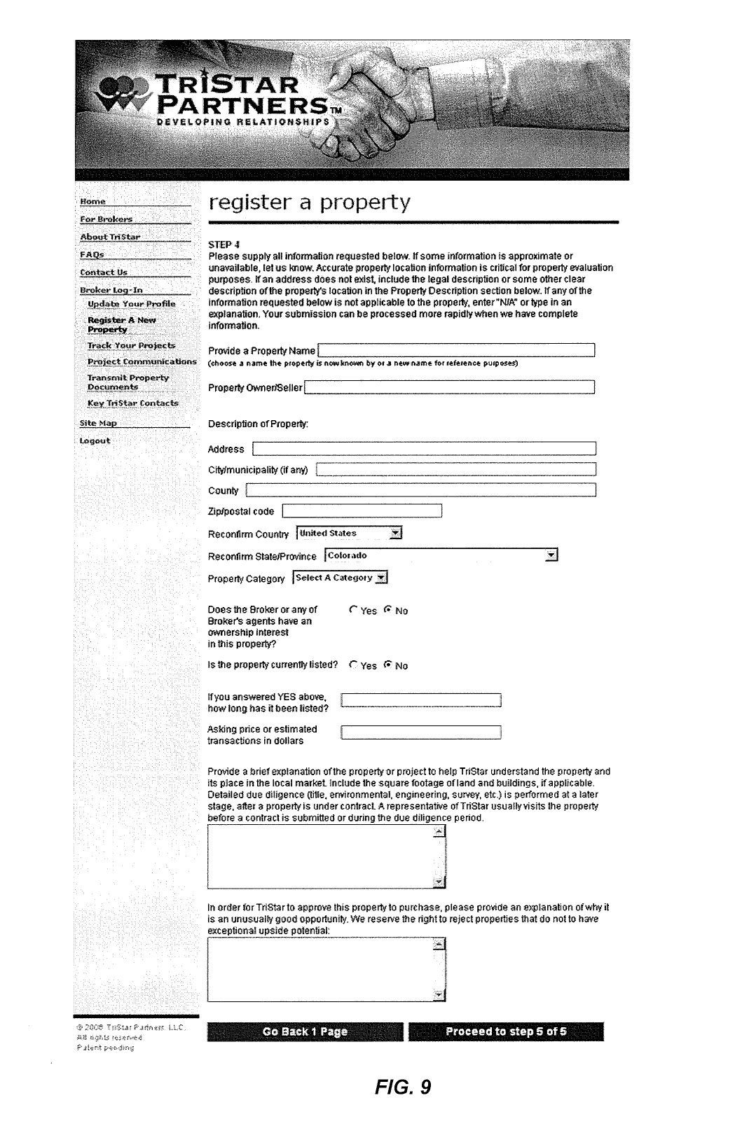

Upon acceptance of the agency agreement by the broker, the receiver will receive submission of the real estate proposal via the computer network. The real estate proposal will generally include more detailed information related to the location of the real estate and a full description of the proposed real estate transaction or development. As illustrated in FIG. 9, the submission of a real estate proposal may include a precise location of the real estate, the property owner, a description of the transaction/development associated with the real estate proposal, estimated investment, costs, etc. In this particular embodiment, the broker is prompted to submit information related to why this particular real estate proposal is an unusually good opportunity. In other embodiments, the receiver may dictate the information necessary to properly evaluate the viability of the real estate proposal.

Once the submission of the real estate proposal is completed, the receiver may employ any necessary steps to evaluate the proposal before deciding to accept or reject the real estate proposal. When the real estate proposal is accepted by the receiver, a transaction or development included in the real estate proposal is closed by one or more of the receiver, a developer or buyer associated with the receiver, and the broker. Upon acceptance of the real estate proposal or closing a portion of the real estate proposal, an interest selected by the broker is conveyed to the broker.

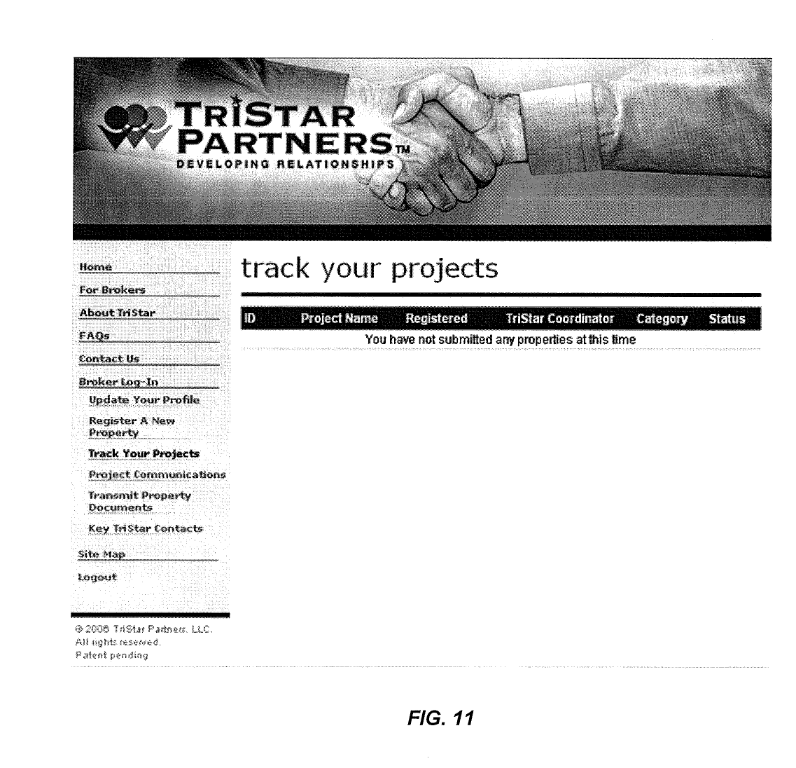

The status of the evaluation of the real estate proposal may be viewable by the broker via a computer network after the submission of the real estate proposal. In the embodiment of FIG. 11, the broker is required to login to the website to view the status of the real estate proposal. When the broker registers the real estate proposal, the broker is assigned an identification number associated with the real estate proposal. After logging-in, the broker may use the identification number to access a webpage related to the status of the particular real estate proposal, as viewable in FIG. 11. Each broker may have more than one real estate proposal under evaluation by the receiver at any given time.

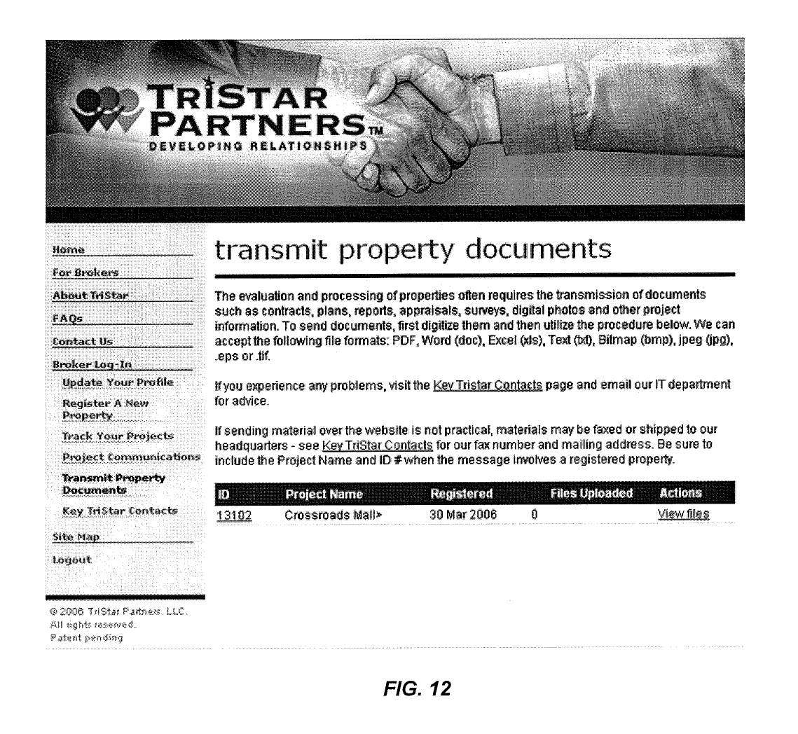

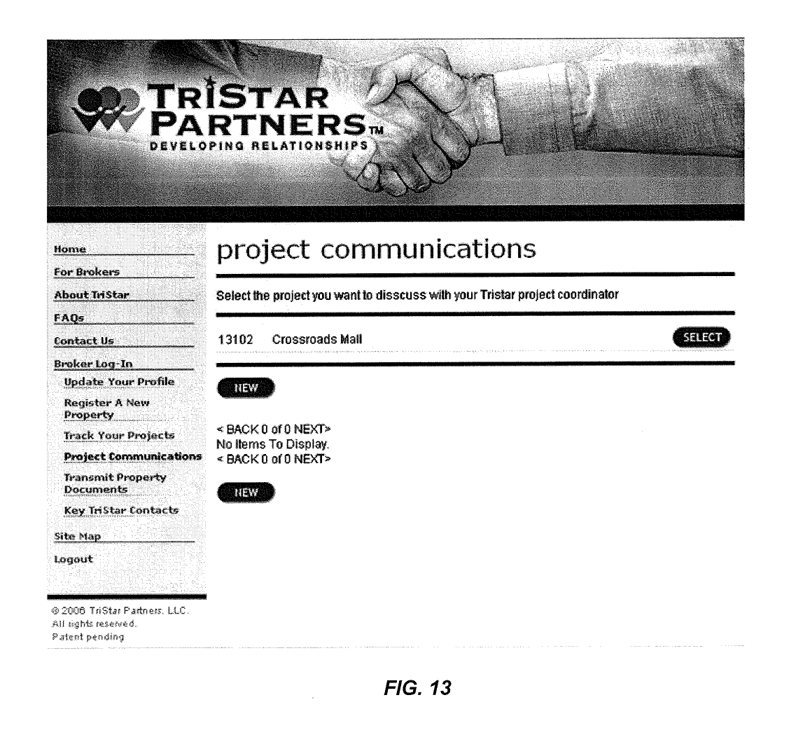

Each real estate proposal includes a different amount of detailed information. In some cases, a webpage as shown in FIG. 9 is sufficient for the broker to submit all the necessary details related to the real estate proposal. For other real estate proposals, the broker may be inclined to upload information to be received by the receiver. FIGS. 12-13 illustrate web pages for uploading one or more documents. In other embodiments, a webpage may be capable of uploading and downloading documents between the receiver, the broker, and another party designated by either the receiver or broker.

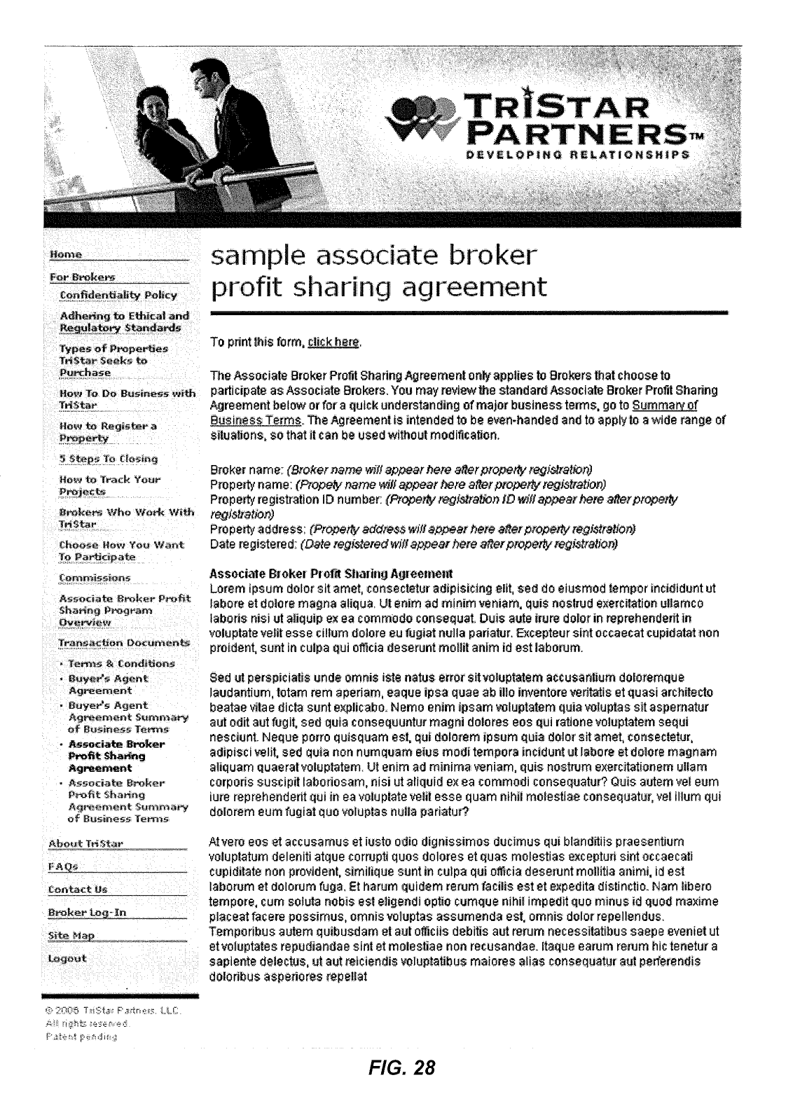

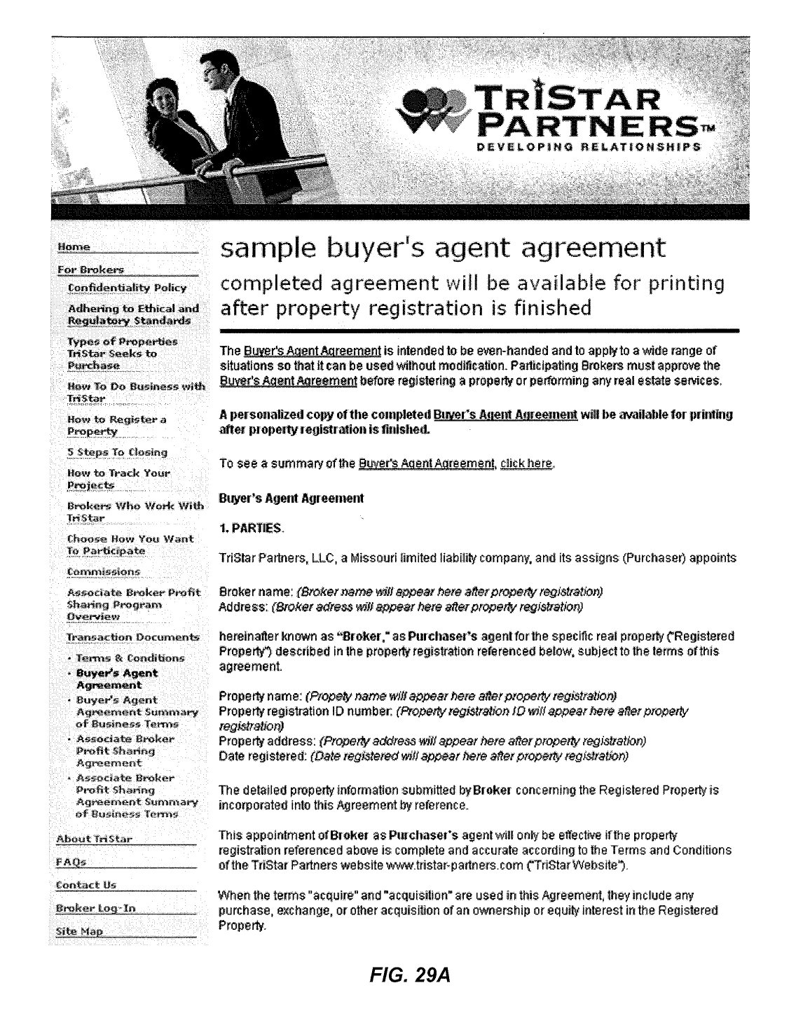

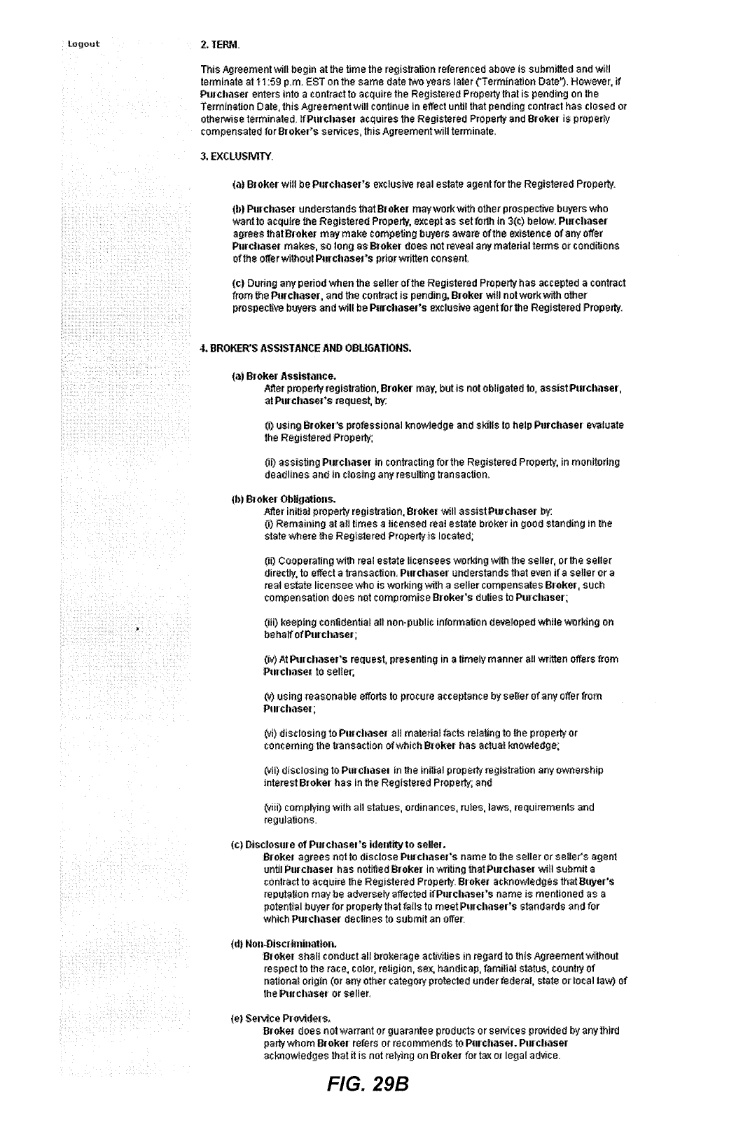

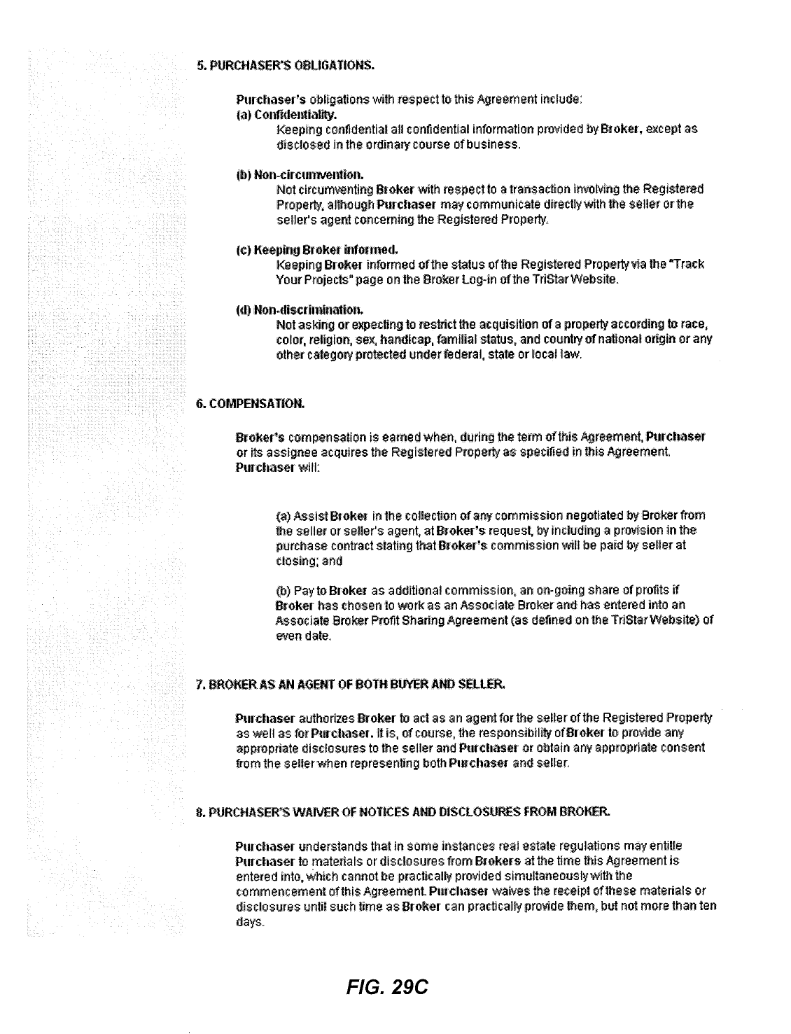

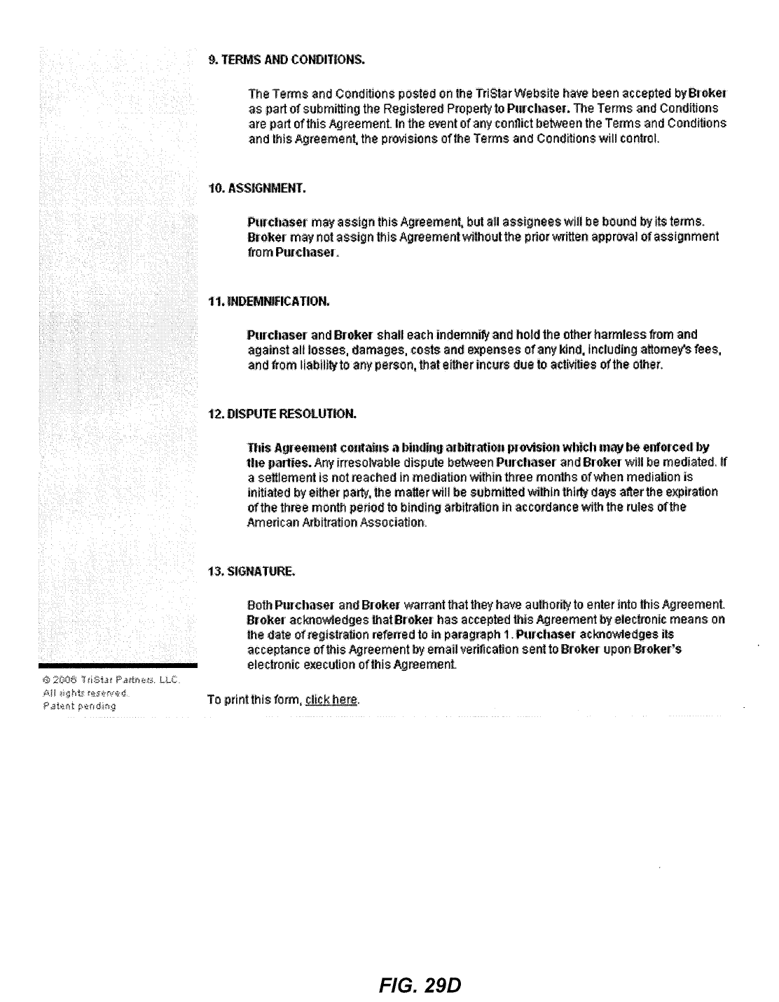

As described above, the agency agreement is generally formed between the receiver and the broker. The agency agreement generally outlines the rights and obligations of the receiver and the broker, as related to the submission of the real estate proposal. Two exemplary agency agreements are summarized in FIGS. 28-29. Other parties may also be included in the agency agreement, such as developers, lenders, another party designated by the receiver or broker, etc.

The agency agreement may also require the broker to handle a portion of local matters related to the real estate proposal. The broker may be required to handle the local matters as his or her contribution rendered in anticipation of the compensation selected during submission of the real estate proposal. Since the broker is familiar with the real estate location, the broker is in a particularly unique situation to handle the local details impacting the real estate proposal.

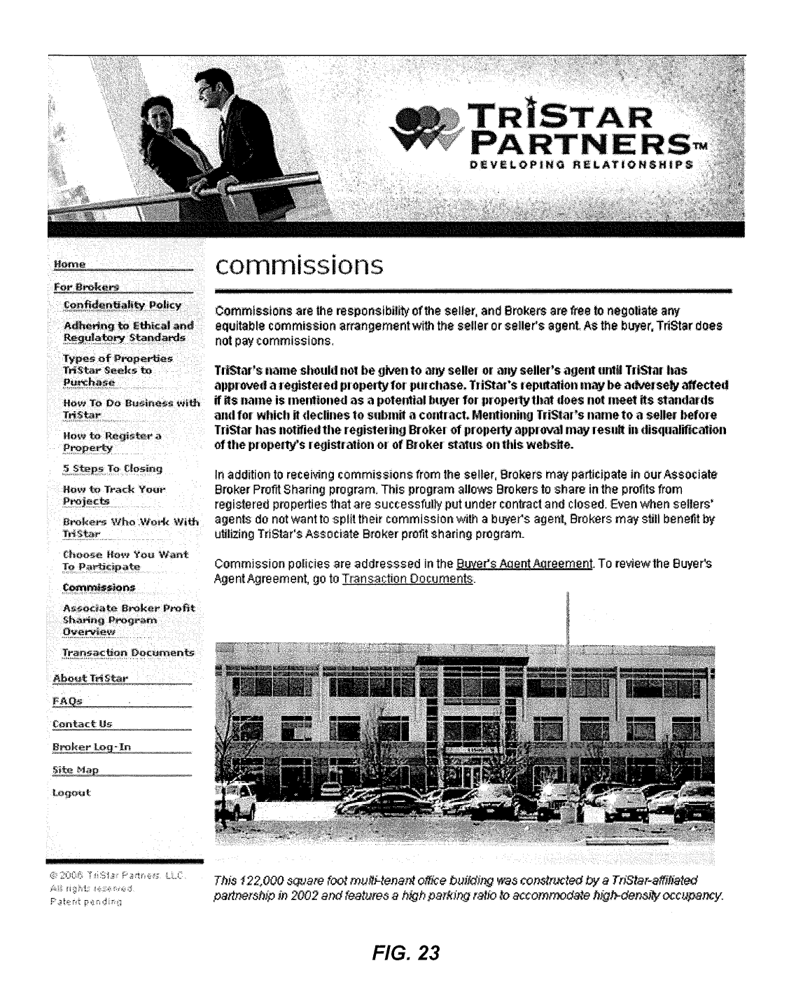

The agency agreement may also prohibit specific receiver or broker behavior. As exemplified in FIG. 23, the broker is prohibited from disclosing the name of the receiver until the real estate proposal is accepted by the receiver. Such a prohibition may serve to protect the reputation of the receiver from statements or actions of the broker. The prohibition may also serve to protect the receiver from liability to a third party. If the broker discloses the receiver to a third party, the receiver may be liable for promises made by the broker to the third party. The agency agreement may prohibit other activity of the broker that may in some form damage, hinder or expose the receiver.

In some situations, the agency agreement will include a non-circumvention clause to protect the broker once the submission is made. The broker may have concerns about disclosing information to the receiver for apprehension that the receiver will proceed without compensating the broker. To offset such concerns, the agency agreement may include the non-circumvention clause. The clause guarantees the receiver's obligation to compensate the receiver for acceptance or closing or the real estate proposal submitted by the broker.

The broker's relationship to the real estate proposal may also affect the agency agreement and the submission of the real estate proposal. For instance, the broker may be a listing agent associate with real estate included in the real estate proposal. A listing agent broker may be required, by fiduciary duty, to reject portions of the agency agreement or certain types of compensation related with the real estate proposal. For this or other reasons, the receiver may restrict a broker from submitting a real estate proposal which includes real estate for which the broker is a listing agent. Alternatively, a receiver may require the broker to be the listing agent for the real estate included in the real estate proposal, because the broker would be in the best position to evaluate the value of the real estate proposal. The receiver may not however be concerned with the broker relationship to real estate included in the real estate proposal.

The relationship of the broker to the real estate is not limited to the broker being the listing agent. In some instances the broker will be the owner of the real estate. In this situation, the parties associated with the real estate proposal would be limited to the broker and the receiver, and possibly another party designated by either the receiver or the broker. Any development or transaction included in the real estate proposal will be between the parties listed above. In other instances, the real estate will be owned by a third party. Under this situation, the receiver or party designated by the receiver will purchase or develop the asset owned by the third party.

The exemplary source code of Appendix A, in compiled form, may be used to provide program instructions configuring system 100 for operations as described herein, where the program instructions may reside on circuitry, for example as shown in the case of server 118. Unless otherwise noted, it will be appreciated that what is shown is a non-limiting embodiment and the circuitry may be more broadly provided on any electronically programmable system, such as a computer having a single processor, multiple processors or in a distributed processing environment. Likewise, data storage may be local to the system, adjunct to a server, or in a distributed or shared database environment.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A software product comprising instructions, stored on computer-readable media, wherein the instructions, when executed by a computer, perform steps for operating a web site to encourage a broker to process real estate opportunities, comprising:
instructions for identifying the broker interacting with the web site;
instructions for receiving a proposal from the broker, the proposal including at least one of the real estate opportunities;
instructions for presenting compensation options to the broker;
instruction for accepting selection of one of the compensation options by the broker; and
instructions for facilitating compensation of the broker upon closure of the real estate opportunity based upon broker's selection of compensation options.

2. The software product of claim 1, wherein the compensation options comprise (a) commission from a seller of the real estate opportunity, (b) participatory interest in the real estate opportunity, and (c) both commission from the seller and participatory interest in the real estate opportunity.

3. The software product of claim 2, wherein the instructions for facilitating comprise instruction for automatically determining an amount to pay broker based upon the selected compensation option.

4. The software product of claim 3, wherein the instructions for automatically determining comprise instructions for periodically determining the amount to pay.

5. The software product of claim 4, wherein the period comprises monthly, yearly or quarterly.

6. The software product of claim 1, further comprising instructions for determining if the real estate opportunity has been previously submitted by another broker.

7. The software product of claim 1, further comprising instructions for generating documentation between the buyer and the broker;

8. The software product of claim 7, further comprising instructions for receiving an electronic signature from the broker, indicating the broker's agreement with the documentation.

9. The software product of claim 1, further comprising instructions for receiving detailed information of the proposal.

10. The software product of claim 9, further comprising instructions for verifying the accuracy of the detailed information.

11. The software product of claim 1, further comprising instructions for registering the broker as the buyer's agent for the real estate opportunity.

12. The software product of claim 1, further comprising instructions for performing due diligence on the real estate opportunity to determine if the opportunity should be taken.

13. The software product of claim 1, further comprising instructions for preparing a contract for a seller of the real estate in the proposal.

14. The software product of claim 13, further comprising instructions for facilitating closure of the contract between the seller and the buyer.

15. The software product of claim 1, further comprising instructions for evaluating the proposal to determine if the proposal represents a viable opportunity to the buyer.

16. The software product of claim 15, wherein the instructions for evaluating comprise instructions for evaluating the real estate opportunity based upon one or more rules.

17. The software product of claim 16, wherein the rules specify acceptable ranges for determined values of the real estate opportunity, the values being determined by searching for real estate property transactions similar to the real estate opportunity.

18. A system for processing a real estate opportunity, comprising:
a database for storing experience data, research data, proposal data and evaluation rules;
a web site host for operating a web site in the internet, the web site host receiving a proposal including the real estate opportunity from a broker interacting with the web site, the web site presenting the broker with a choice of compensation options and receiving a compensation option selection from the broker;
an evaluation module for utilizing the database to determine if the real estate opportunity is acceptable to a buyer, the evaluation module generating a contract between a seller of the real estate of the real estate opportunity and the buyer if the real estate opportunity is acceptable;
wherein the broker receives the selected compensation upon closure of the contract.

19. A software product comprising instructions, stored on computer-readable media, wherein the instructions, when executed by a computer, perform steps for operating a web site to encourage a broker to present a real estate opportunity and automatically determining if the real estate opportunity is suitable for a buyer, comprising:
instructions for identifying the broker interacting with the web site;
instructions for receiving a proposal from the broker, the proposal including the real estate opportunity;
instructions for presenting a choice of compensation options to the broker;
instructions for accepting a compensation selection from the broker;
instructions for generating documentation between the buyer and the broker;
instructions for receiving the broker's electronic signature indicating the broker's agreement with the documentation;
instructions for receiving detailed information of the proposal;
instructions for determining if the real estate opportunity has been previously submitted by another broker;
instructions for verifying the accuracy of the proposal;
instructions for registering the broker and the proposal;
instructions for evaluating the proposal to determine if the proposal is suitable for presenting to the buyer;
instructions for preparing a contract for a seller of the real estate in the proposal;
instructions for performing due diligence on the real estate of the proposal to determine if the opportunity should be taken;
instructions for facilitating closure of the contract between the seller and the buyer; and
instructions for compensating the broker based upon the broker's compensation selection.
